(19) United States
(12) Patent Application Publication
(10) Pub. No.: US 2025/0123189 A1
(43) Pub. Date: Apr. 17, 2025

(54) SAMPLE PREPARATION MATRIX, SYSTEM, METHOD OF MAKING, METHOD OF USING, AND KIT COMPRISING MATRIX

(71) Applicant: Pierce Biotechnology Inc., Rockford, IL (US)

(72) Inventors: Ramesh Ganapathy, Rockford, IL (US); Barbara Kaboord, Oregon, WI (US); Ashok Salunkhe, Rockton, IL (US); Suzanne Smith, Rockton, IL (US); Christopher Etienne, Oregon, WI (US)

(73) Assignee: Pierce Biotechnology Inc., Rockford, IL (US)

(21) Appl. No.: 18/777,343

(22) Filed: Jul. 18, 2024

Related U.S. Application Data
(60) Provisional application No. 63/527,777, filed on Jul. 19, 2023.

(51) Int. Cl. G01N 1/34

(52) U.S. Cl. CPC G01N 1/34

(57) ABSTRACT

Disclosed herein are aspects of a matrix, typically comprising a rigid resin, for purifying samples, such as by separating one or more small molecules from one or more large molecules in a sample. Also disclosed is a method of making the matrix, a method of using the matrix, systems comprising the matrix, and kit aspects. Disclosed aspects comprising a porous size exclusion support and an amine-containing moiety can be used in small and large spin column formats and can be equilibrated with a wide range of buffers.

### CROSS REFERENCE TO RELATED APPLICATION

This application claims the benefit of and priority to the earlier filing date of U.S. Provisional Application No. 63/527,777, filed on Jul. 19, 2023, the entirety of which is incorporated herein by reference.

### FIELD

The present specification concerns a matrix, system, method, and kit for purifying chemical compounds, such as by separating small molecules from large molecules in a sample.

### BACKGROUND

Sample preparation techniques for isolating biomolecules may involve separating smaller (e.g., lower molecular weight) sample components from larger sample components (e.g., large molecular weight) and from sample processing components to enable downstream analysis and processing of the sample components. For example, during preparation of samples comprising biomolecules there is a need for removing proteins having a low molecular weight, while effectively recovering proteins with a higher molecular weight.

There is a need in the art for an improved matrix, system comprising the matrix, and method of making and using the matrix for separating larger proteins from smaller proteins and for recovering low concentration and/or low abundance proteins. Such technologies preferably are configured for use in small and large column formats, and enable cleaner downstream processing of the biomolecules (e.g., fluorescent imaging, bioconjugation, immunoprecipitation, and the like)

### SUMMARY

Disclosed aspects of the present disclosure advantageously provide superior separation of small molecules from large molecules in any suitably sized column and additionally reduce time and expense associated with such separations to, for example, facilitate downstream processing of separated components relative to known processes. Aspects of the present disclosure advantageously provide recovery of proteins present in low concentrations in a sample, such as lower abundance proteins and/or samples with low concentrations of proteins.

Certain disclosed examples concern a matrix comprising a porous size exclusion support having a molecular weight cut-off (MWCO) greater than 30,000 Da (30 kDa), wherein the porous size exclusion support is a reaction product comprising 2-hydroxyethyl cellulose and epichlorohydrin and can further comprise at least one amine-containing moiety associated with the porous size exclusion support. In particular aspects disclosed herein, the porous size exclusion support can have a MWCO ranging from greater than 30,000 Da to 45,000 Da. In some aspects, the porous size exclusion support was produced by crosslinking 2-hydroxyethyl cellulose with epichlorohydrin. For certain disclosed examples, the matrix may comprise a modified porous size exclusion support, such as a dextran, a cyclodextrin (e.g., β-cyclodextrin, α-cyclodextrin, γ-cyclodextrin, and the like), a chemically modified cellulose, and/or a modification reagent, and/or crosslinker, such as but not limited to, an epoxide containing modification reagent and/or crosslinker. Particular examples of the modification reagents and/or crosslinkers may include, but are not limited to, epoxybutane, epoxyhexane, epoxypropane, dimethylsulfate, diglycidyl ether, or any combination thereof. In some aspects, modification reagents are used to pre-modify the matrix. In certain aspects, the modification reagents can be used in the post modification of the matrix.

For certain aspects, the amine-containing moiety may be selected for its hydrophobic properties. For example, the amine-containing moiety may be a hydrophobic amine-containing moiety associated with the porous size exclusion support. Prior to association with the porous size exclusion support, the amine-containing moiety typically is a monoamine, a diamine, or a polyamine. Particular examples of suitable amine-containing moieties include aliphatic amines, aliphatic diamines, or aliphatic polyamines, particularly alkyl amines, alkyl diamines. For certain aspects, the amine-containing moiety is covalently bound to the porous size exclusion support. The matrix typically is advantageously equilibrated with an equilibration buffer, such as a phosphate buffer.

The present system also provides for a system for separating small molecules from large molecules in a sample. Such systems comprise a container with a disclosed matrix, and a receptacle located to receive flow from the container. The system may be configured for gravity flow operation, centrifugal force operation, positive pressure operation, negative pressure operation, vacuum operation, or combinations thereof. The container may be any suitable container, such as a columnar container, a tube, a multi-well tube, a multi-well plate, or a multi-well filter plate. Any suitable sized column can be used to practice the present disclosure, but in certain disclosed aspects, the column had a volume of from 0.005 mL (5 μL) to 50 mL.

A method of making a rigid size exclusion resin is also disclosed. The method comprises providing a porous size exclusion support comprising 2-hydroxyethyl cellulose having a MWCO greater than 30,000 Da, the 2-hydroxyethyl cellulose having at least one vicinal diol. The vicinal diol is oxidized to form an aldehyde, and the aldehyde is then reacted with an amine group of an amine-containing moiety via reductive amination using, for example, sodium cyanoborohydride or amine boranes such as triethylamine borane.

A method for separating at least one small molecule from at least one large molecule in a sample is also disclosed. The method comprises providing a disclosed matrix comprising a porous size exclusion support having at least one amine-containing moiety associated therewith. Sample is then applied to the matrix to separate the small molecule from the large molecule by flowing sample through the matrix by gravity flow, a centrifugal force, a positive pressure, a negative pressure, a vacuum, or a combination thereof. The large molecule in the sample is excluded by the matrix and is collected as a first flow through in a receptacle located to receive the flow through. The disclosed method substantially increases the ability to separate small molecules from the sample in small and large column formats and substantially increases the recovery of the large molecule. This in turn facilitates processing the large molecule in downstream applications.

A kit for separating large molecules from small molecules is also disclosed. The kit may comprise a disclosed porous size exclusion support having at least one amine-containing moiety associated therewith, and instructions for using the porous size exclusion support. The kit may further comprise an equilibration buffer, and/or a system comprising a container housing the porous size exclusion support, and a receptacle positioned to receive flowthrough the support.

The foregoing and other objects, features, and advantages of the present disclosure will become more apparent from the following detailed description, which proceeds with reference to the accompanying figures.

### BRIEF DESCRIPTION OF THE DRAWINGS

FIG. 1A is a schematic drawing illustrating one disclosed aspect comprising modifying a porous size exclusion support with a modifying reagent prior to crosslinking the porous size exclusion support.

FIG. 1B is a schematic drawing illustrating one disclosed aspect comprising associating a porous size exclusion support with an amine-containing moiety.

FIG. 2 is a schematic side view of one aspect of a system according to the present disclosure comprising a container and a receptacle for processing a sample to separate at least one small molecule from at least one large molecule by flowing the sample through the matrix.

FIG. 3A is a schematic perspective view of one aspect of a system according to the present disclosure comprising a container and a receptacle for processing a sample to separate at least one small molecule from at least one large molecule, wherein the system comprises a multi-well container and a receptacle.

FIG. 3B is a schematic perspective view of one aspect of a system according to the present disclosure comprising a container and a receptacle for processing a sample to separate at least one small molecule from at least one large molecule, wherein the system comprises a multi-well container and a receptacle.

FIG. 4 is a schematic drawing illustrating one disclosed aspect of a method for using a matrix comprising a porous size exclusion support and an amine-containing moiety.

FIG. 5A is a bar graph concerning Resin A versus Cytiva G 50 (Sigma-Aldrich) comparing the separation of Aprotinin (6,500 Da); Ubiquitin (8,500 Da); Lactalbumin (14,000 Da); Trypsin Inhibitor (20,000 Da); Carbonic Anhydrase (30,000 Da); and demonstrates that a comparative resin (also referred to herein as “Resin A”) does not have a 40,000 Da MWCO due to the high recovery of smaller proteins having a molecular weight from 6,500 Da to 30,000 Da, which is below the 40,000 Da cut-off, unlike Cytiva G 50.

FIG. 5B is a bar graph concerning Resin A versus Cytiva G 50 comparing the separation of Ovalbumin (42,000 Da); Protein A (45,000 Da); BSA (67,000 Da); Transferrin (80,000 Da); Rabbit IgG (150,000 Da); and illustrating Resin A and Cytiva G 50 having similar recoveries of larger proteins greater than 40,000 Da.

FIG. 5C is a bar graph showing the sample recovery volume percentage of Resin A in a 10 mL spin column sampled from eight different lots thereby demonstrating inconsistent sample volume recovery across the eight different lots, showing high lot-to-lot variability.

FIG. 6 is a bar graph concerning an example of the disclosure referred to herein as Resin B comprising a porous size exclusion support comprising 25% less 2-hydroxyethyl cellulose than Resin A versus the Cytiva G 50 comparing the separation of smaller proteins Ubiquitin (8,500 Da); Lactalbumin (14,000 Da), Trypsin Inhibitor (20,000 Da), Carbonic Anhydrase (30,000 Da); from larger proteins Ovalbumin (42,000 Da), Transferrin (80,000 Da), Rabbit IgG (150,000 Da); and demonstrating that by reducing the amount of 2-hydroxyethyl cellulose by 25% from Resin A resulted in similar recovery of smaller proteins to the Cytiva G 50 results, and thus exhibiting a 40,000 Da MWCO.

FIG. 7 is a bar graph depicting the protein recovery and volume recovery using 10 mL spin columns of Resin B showing aspects of the present disclosure comprising a lower amount of HEC had low protein recovery of BSA (67,000 Da) and did not improve the volume recovery in larger sized spin columns.

FIG. 8 is a bar graph of an example of the disclosure concerning Resin C comprising a porous size exclusion support comprising 25% less HEC and 50% more epichlorohydrin (“Epi”) than Resin A versus Cytiva G 50 comparing the separation of Aprotinin (6,500 Da); Ubiquitin (8,500 Da); Lactalbumin (14,000 Da), Trypsin Inhibitor (20,000 Da); Carbonic Anhydrase (30,000 Da); Ovalbumin (42,000 Da); BSA (67,000 Da); Transferrin (80,000 Da); Rabbit IgG (150,000 Da); demonstrating that decreasing HEC by 25% and increasing the Epi by 50% more than Resin A, resulted in a 40,000 Da MWCO (denoted by the arrow), which is demonstrated by the lower recovery percentage of smaller proteins having a molecular weight of from 6,500 Da to 30,000 Da and higher recovery percentage of larger proteins (greater than 30,000 Da).

FIG. 9 is a bar graph of an example of the disclosure depicting the BSA (67,000 Da) protein recovery and volume recovery using 10 mL spin columns of Resin C as specified in Table 1 versus Resin B as specified in Table 1 and demonstrating that increasing the amount of crosslinker (Epi) by 50% improved the volume recovery property.

FIG. 10A is a bar graph of an example of the disclosure, referred to herein as Resin D, comprising a post modified size exclusion support comprising 25% less HEC and 50% more Epi than Resin A and modified with O-(2-Aminopropyl)-O′-(2-methoxyethyl)polypropylene glycol (MJ) versus the Cytiva G 50 comparing the separation of Aprotinin (6,500 Da); Ubiquitin (8,500 Da); Lactalbumin (14,000 Da); Trypsin Inhibitor (20,000 Da); Carbonic Anhydrase (30,000 Da); and demonstrates similar lower protein recovery to Cytiva G 50, and thus indicating a 40,000 Da MWCO for Resin D.

FIG. 10B is a bar graph of an example of the disclosure concerning Resin D as specified in Table 1 versus Cytiva G 50 comparing the separation of Ovalbumin (42,000 Da); Protein A (45,000 Da); BSA (67,000 Da); Transferrin (80,000 Da); Rabbit IgG (150,000 Da); and demonstrating similar amount of larger protein recovery between Resin D and Cytiva G 50.

FIG. 11 is a bar graph of an example of the disclosure, referred to herein as Resin E, comprising a post modified size exclusion support comprising 25% less HEC and 50% more Epi than Resin A and modified with 1,5-diaminopentane (PDA) versus Cytiva G 50 Aprotinin (6,500 Da); Ubiquitin (8,500 Da); Lactalbumin (14,000 Da), Trypsin Inhibitor (20,000 Da); Carbonic Anhydrase (30,000 Da); Ovalbumin (42,000 Da); BSA (67,000 Da); Transferrin (80,000 Da); Rabbit IgG (150,000 Da); and demonstrates similar protein recoveries with smaller (less than 30,000 Da) and larger (>30,000 Da) proteins as to Cytiva G 50, thereby indicating a 40,000 Da MWCO.

FIG. 12 is a bar graph comparing BSA protein (67,000 Da) and volume recovery in 10 mL spin columns comprising the Resin C example comprising an unmodified porous size exclusion support comprising 25% less HEC and 50% more Epi than Resin A, versus a Resin D example comprising a post modified porous size exclusion support comprising 25% less 2-hydroxyethyl cellulose and 50% more Epi than Resin A modified with MJ versus a Resin C example post modified porous size exclusion support comprising 25% less 2-hydroxyethyl cellulose and 50% more Epi than Resin A modified with PDA; and demonstrating an improvements in both the protein and volume recovery in both post modified size exclusion supports as compared to the unmodified Resin C example.

FIG. 13A is a line graph comparing the BSA protein (67,000 Da) recovery in 10 mL over a 6-month period of Resin A versus a Resin D example comprising a post modified porous size exclusion support comprising 25% less 2-hydroxyethyl cellulose and 50% more Epi than Resin A modified with MJ; demonstrating a significant improvement in the stability of the protein recovery over time in the post modified porous size exclusion support comprising 25% less 2-hydroxyethyl cellulose and 50% more Epi than Resin A modified with O-(2-Aminopropyl)-O′-(2-methoxyethyl)polypropylene glycol compared to Resin A.

FIG. 13B is a line graph comparing the volume recovery in 10 mL over a 6-month period of Resin A versus a Resin D example comprising a post modified porous size exclusion support comprising 25% less 2-hydroxyethyl cellulose and 50% more Epi than Resin A modified with MJ; and demonstrating a significant improvement of the stability in the volume recovery over time in the post modified porous size exclusion support comprising 25% less 2-hydroxyethyl cellulose and 50% more Epi.

FIG. 14 is a bar graph concerning a Resin D example comprising a post modified porous size exclusion support comprising 25% less 2-hydroxyethyl cellulose and 50% more Epi than the Resin A modified with MJ versus Resin A and Cytiva G 50 comparing the MWCOs in a 0.5 mL spin column, 2 mL spin column, 5 mL spin column, and 10 mL spin column and comparing the recovery of Lactalbumin (14,000 Da), Trypsin Inhibitor (20,000 Da); Ovalbumin (42,000 Da); BSA (67,000 Da); demonstrating the Resin D example comprising a post modified porous size exclusion support comprising 25% less 2-hydroxyethyl cellulose and 50% more Epi than Resin A modified with MJ had similar performance to Cytiva G 50, and thereby exhibiting a 40,000 Da MWCO.

FIG. 15A is an image of a silver-stained gel comparing the recovery of IgG 250 ng loaded onto a Resin C example (as described in Table 1, provided herein), Resin D example (as described in Table 1, provided herein), Cytiva G 50, and Bio Rad P 30, wherein the Resin D example displayed the thickest bands, followed by the Resin C example, Cytiva G 50, and Bio-Rad P-30; thus, this figure shows that the post modification chemistry with MJ enabled a higher protein recovery at low protein loads.

FIG. 15B is a bar graph showing band quantification from the silver-stained gel of FIG. 15A using iBright Image Analysis software demonstrating the Resin D example (as described in Table 1, provided herein) having an 82% IgG recovery, the Resin C example (as described in Table 1, provided herein) having a 60% IgG recovery, Cytiva G 50 having a 25% IgG recovery, and Bio-Rad P-30 (Bio-Rad Laboratories) having a 12% IgG recovery.

FIG. 16 is a bar graph comparing the rabbit IgG (100 μg load on 10 mL spin column) and volume recovery (10 mL spin column) of a Resin D example (as described in Table 1, provided herein) versus a Resin C example (as described in Table 1, provided herein), showing the Resin D example having a 90% rabbit IgG recovery and a 100% volume recovery and the Resin C example having a 76% rabbit IgG recovery and a 188% volume recovery and thus this figure shows at least one an advantage of the post modification with MJ in the Resin D example by having a higher protein recovery a desirable volume recovery within the range of 80% to 120%.

FIG. 17 is a bar graph comparing the Goat Anti-Rabbit (GAR) Dy650 conjugate recovery (1 mg/mL) and Free Dylight 650 removal of a Resin D example versus a Resin C example, the Resin D example had an 81% GAR Dylight 650 conjugate recovery and a 95% removal of Free Dylight 650, and the Resin C example had a 68% GAR Dylight 650 conjugate recovery and 99% removal of Free Dylight 650; thus, this figure shows the efficiency of free dye removal between the Resin D example and the Resin C example were comparable but that the Resin D example exhibited a higher GAR Dylight 650 conjugate recovery than Resin C example.

FIG. 18A is an image of a silver-stained gel of 250 ng BSA load of Resin D example (as described in Table 1, provided herein) versus Cytiva G 50 and Bio-Rad P-30, wherein the Resin D example displayed thicker bands than Cytiva G 50 and Bio-Rad P-30 therefore showing higher protein recovery at low protein loads versus commercially available resins Cytiva G 50 and Bio-Rad P-30.

FIG. 18B is a bar graph showing band quantification from the silver-stained gel of FIG. 18A using iBright Image Analysis software showing the Resin D example having a 66% BSA recovery, Cytiva G 50 having a 8% BSA recovery, and Bio-Rad P-30 having a 7% BSA recovery; thus, this figure shows that the Resin D example exhibits superior performance in recovering low amounts of BSA in comparison to commercially available resins Cytiva G 50 and Bio-Rad P-30.

FIG. 19A is an image of a silver-stained gel of 250 ng IgG load of a Resin D example (as described in Table 1, provided herein) versus Cytiva G 50 and Bio-Rad P-30, wherein the Resin D example displayed thicker bands than Cytiva G 50 and Bio-Rad P-30; thus, this figure shows that the Resin D example exhibits higher protein recovery at low protein loads versus commercially available resins Cytiva G 50 and Bio-Rad P-30.

FIG. 19B is a bar graph showing the band quantification from the silver-stained gel of FIG. 19A using Bright Image Analysis software demonstrating the Resin D example having a 55% IgG recovery, Cytiva G 50 having a 5% IgG recovery, and Bio-Rad P-30 having a 3% IgG recovery; thus, this figure shows that the Resin D example exhibits superior performance in recovering low amounts of IgG in comparison to commercially available resins Cytiva G 50 and Bio-Rad P-30.

FIG. 20 is a bar graph showing the rabbit IgG recovery (100 μg load) and volume recovery (10 mL resin bed) of a Resin D example (as described in Table 1, provided herein) versus Cytvia G 50 and Bio-Rad P-30; showing a 90% rabbit IgG recovery and a 100% volume recovery for the Resin D example; a 77% rabbit IgG recovery and 98% volume recovery for Cytiva G 50; a 55% rabbit IgG recovery and 88% volume recovery for Bio-Rad P-30; thus, this figure shows comparable volume recoveries for the Resin D example and commercially available resins Cytiva G 50 and Bio-Rad P-30, but the Resin D example exhibited superior performance in recovering low amounts of protein in comparison to commercially available resins Cytiva G 50 and Bio-Rad P-30.

FIG. 21 is a bar graph showing the recovery of Goat Anti-Rabbit (GAR) Dy650 conjugate and removal of Free DyLight 650 (0.5 mL resin bed) of a Resin D example versus Cytiva G 50; the Resin D example had an 81% GAR recovery and a 95% Free Dylight 650 removed; Cytiva G 50 had a 79% GAR recovery and a 79% Free Dylight 650 removed; thus, this figure shows that the Resin D example had comparable GAR Dylight 650 recovery for the Resin D example and Cytiva G 50; but the Resin D example exhibited superior performance in free dye removal.

FIG. 22 is an image of a silver-stained gel used for collecting flowthrough after loading 0.1 mg/mL of A 549 lysate loaded at 50 μL (μg load) on Resin D example, Cytiva G 50, and Bio-Rad P-30; the silver-stain gel exhibited a darker band above 40,000 Da for the Resin D example than Cytiva G 50 and Bio-Rad P-30; thus, this figure shows that the Resin D example had a higher protein recovery for proteins greater than 40,000 Da in comparison to commercially available resins Cytiva G 50 and Bio-Rad P-30.

### DETAILED DESCRIPTION

### I. Abbreviations

Epi: Epichlorohydrin
HEC: 2-Hydroxyethyl cellulose
MJ: O-(2-Aminopropyl)-O′-(2-methoxyethyl)polypropylene glycol (also known as Jeffamine® M-600; 2,5,9,13-tetraoxahexadecan-15-amine; polypropylene glycol 500 mono-2-aminoethyl mono-2-methoxyethyl ether)
MWCO: Molecular weight cut-off
PDA: 1,5-Diaminopentane

### III. Terms, Ranges, and Definitions

Both the foregoing general description and the following detailed description are exemplary and explanatory only and are not intended to limit the scope of the present disclosure.

As used herein, the use of the singular includes the plural unless specifically stated otherwise. For example, the singular forms “a, “an”, and “the” as used in the specification also include plural aspects unless the context dictates otherwise. Similarly, any singular term used in the specification also means plural or vice versa, unless the context dictates otherwise.

The term “or combinations thereof” as used herein refers to all permutations and combinations of the listed items preceding the term. For example, “A, B, C, or combinations thereof” is intended to include at least: A, B, C, AB, AC, BC, or ABC, and if order is important in a particular context, also BA, CA, CB, ACB, CBA, BCA, BAC, or CAB. Continuing with this example, expressly included are combinations that contain repeats of one or more item or term, such as BB, AAA, AAB, BBC, AAABCCCC, CBBAAA, CABABB, and so forth.

The term “acyl halide” generally refers to —C(O)X, wherein X is a halogen, such as Br, F, I, or Cl.

The term “alcohol” generally refers to an organic compound including at least one hydroxyl group. Alcohols may be monohydric (including one —OH group), dihydric (including two —OH groups; diols, such as glycols), trihydric (including three —OH; triols, such as glycerol) groups, or polyhydric (including two or more —OH groups; polyols). The organic portion of the alcohol may be aliphatic, cycloaliphatic (alicyclic), heteroaliphatic, cycloheteroaliphatic (heterocyclic), polycyclic, aryl, or heteroaryl, and may be substituted or unsubstituted.

The term “aldehyde” generally refers to a carbonyl-bearing functional group having a formula

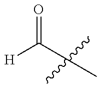 [SMILES: *C=O]

where the wavy line indicates that the functional group can be attached to any other moiety, but that such moiety simply is not indicated.

The term “aliphatic” generally refers to a substantially hydrocarbon-based compound, or a radical thereof (e.g., C₆H₁₃, for a hexane radical), including alkanes, alkenes, alkynes, including cyclic versions thereof, and further including straight- and branched-chain arrangements, and all stereo and position isomers as well. Unless expressly stated otherwise, an aliphatic group typically comprises from one to twenty-five carbon atoms; for example, from one to fifteen, from one to ten, from one to six, or from one to four carbon atoms. The term “lower aliphatic” refers to an aliphatic group containing from one to ten carbon atoms. An aliphatic chain may be substituted or unsubstituted. Unless expressly referred to as an “unsubstituted aliphatic,” an aliphatic group can either be unsubstituted or substituted. An aliphatic group can be substituted with one or more substituents (up to two substituents for each methylene carbon in an aliphatic chain, or up to one substituent for each carbon of a C═C double bond in an aliphatic chain, or up to one substituent for a carbon of a terminal methine group). Exemplary substituents include, but are not limited to, alkyl, alkenyl, alkynyl, alkoxy, alkylamino, alkylthio, acyl, aldehyde, amide, amino, aminoalkyl, aryl, arylalkyl, carboxyl, cyano, cycloalkyl, dialkylamino, halo, haloaliphatic, heteroaliphatic, heteroaryl, heterocycloaliphatic, hydroxyl, oxo, sulfonamide, sulfhydryl, thioalkoxy, or other functionality. Optionally, aliphatic moiety includes one or more heteroatoms in the linear, branched, or cyclic hydrocarbon chain. For example, an aliphatic moiety can include one or more oxygen atoms that can be a main chain or in a substituent.

The term “alkoxy” generally refers to radical (or substituent) having the structure —OR, where R is a substituted or unsubstituted alkyl.

The term “alkyl” generally refers to a hydrocarbon group having a saturated carbon chain. The chain may be cyclic, branched, or unbranched.

The term “alkynyl” generally refers to an organic compound having at least one carbon-carbon triple bond. An alkynyl group can be branched, straight-chain, or cyclic (e.g., cycloalkynyl).

The term “amide” generally refers to chemical functional group —C(O)N(R)(R′) where R, R′ and R″ independently hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “amino” generally refers to a chemical functional group —N(R)R′ where R and R′ are independently hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “antibody” generally refers to immunoglobulins or immunoglobulin-like molecules (including by way of example and without limitation, IgA (Immunoglobulin A), IgD (Immunoglobulin D), IgE (Immunoglobulin E), IgG (Immunoglobulin E) and IgM (Immunoglobulin M), combinations thereof, and similar molecules produced during an immune response in any chordate such as a vertebrate, for example, in mammals such as humans, goats, rabbits and mice) and fragments thereof that specifically bind to a molecule of interest (or a group of highly similar molecules of interest) to the substantial exclusion of binding to other molecules. An “antibody” typically comprises a polypeptide ligand having at least a light chain or heavy chain immunoglobulin variable region that specifically recognizes and binds an epitope of an antigen. Immunoglobulins are composed of a heavy and a light chain, each of which has a variable region, termed the variable heavy (V_{H}) region and the variable light (V_{L}) region. Together, the V_{H} region and the V_{L} region are responsible for binding the antigen recognized by the immunoglobulin. Exemplary immunoglobulin fragments include, without limitation, proteolytic immunoglobulin fragments [such as F(ab′)₂ fragments, Fab′ fragments, Fab′-SH fragments and Fab fragments as are known in the art], recombinant immunoglobulin fragments (such as sFv fragments, dsFv fragments, bispecific sFv fragments, bispecific dsFv fragments, ‘F(ab)’₂ fragments, single chain Fv proteins (“scFv”), and disulfide stabilized Fv proteins (“dsFv”). Other examples of antibodies include diabodies, and triabodies (as are known in the art), and camelid antibodies. “Antibody” also includes genetically engineered molecules, such as chimeric antibodies (for example, humanized murine antibodies), and heteroconjugate antibodies (such as, bispecific antibodies). See also, Pierce Catalog and Handbook, 1994-1995 (Pierce Chemical Co., Rockford, IL); Kuby, J., Immunology, 3^{rd} Ed., W.H. Freeman & Co., New York, 1997.

The term “aromatic” generally refers to a cyclic or conjugated group comprising, unless specified otherwise, from 5 to 15 ring atoms having at least a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Hückel rule (4n+2). The point of attachment to the parent structure typically is through an aromatic portion of the condensed ring system. For example,

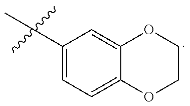 [SMILES: *c1ccc2c(c1)OCCO2]

However, in certain examples, context or express disclosure may indicate that the point of attachment is through a non-aromatic portion of the condensed ring system. For example,

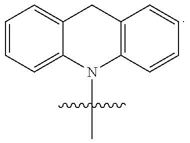 [SMILES: *N1c2ccccc2Cc2ccccc21]

An aromatic group may comprise only carbon atoms in the ring, such as in an aryl group, or it may comprise one or more ring carbon atoms and one or more ring heteroatoms comprising a lone pair of electrons (e.g., S, O, N, P, or Si), such as in a heteroaryl group. Aromatic groups may be substituted with one or more groups other than hydrogen, such as alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality, or an organic functional group.

The term “aryl” generally refers to an aromatic carbocyclic group comprising at least five carbon atoms to 15 carbon atoms (C₅-C₁₅), such as five to ten carbon atoms (C₅-C₁₀), having a single ring or multiple condensed rings, which condensed rings can or may not be aromatic provided that the point of attachment to a remaining position of the compounds disclosed herein is through an atom of the aromatic carbocyclic group. Aryl groups may be substituted with one or more groups other than hydrogen, such as alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “carbamate” generally refers to a functional group having a formula

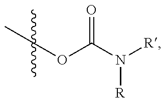

wherein R and R′ independently are hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “carbonate” generally refers to a functional group with the formula —OCO₂R where R is hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “carboxamide” generally refers to the group acyl, or —C(O)amino, where R is hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “carboxyl” generally refers to —C(O)OH.

The term “carboxylic acid” generally refers to an organic compound having a formula RCOOH where R is hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “cellulose” generally refers to a naturally occurring polysaccharide of about 70 to more than 10,000 β(1→4) linked D-glucose units in a linear chain. Cellulose has the general formula (C₆H₁₀O₅)ₙ:

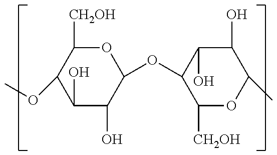

Cellulose is a structural component of plant cell walls. About one third of plant matter is cellulose. Wood contains approximately 50% cellulose by weight. Cellulose polymers can be characterized by the degree of polymerization, which is the number of monomer units, i.e., glucose units. Cellulose polymers may contain from several hundred to several thousand glucose units. For example, the degree of polymerization can range from about 1000 for wood pulp to about 3500 for cotton fiber. Cellulose can be decomposed into glucose by hydrolysis or by the enzyme cellulase.

The term “cyano” generally refers to —CN.

The term “disulfide” generally refers to general formula R—S—S—R′ wherein R and R′ are independently hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “epoxide” generally refers to a cyclic ether comprising a 3-membered ring and having a general formula,

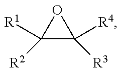

where R¹-R⁴ independently are hydrogen, alkyl, alkanes, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “ester” generally refers to a chemical compound having a formula

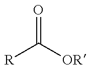

where R and R′ are independently alkyl, heteroalkyl, haloalkyl, aliphatic, heteroaliphatic, haloaliphatic, aryl (such as optionally substituted phenyl or benzyl), heteroaryl, haloaryl, alkylsulfano, glycidyl ether or other functionality.

The term “ether” generally refers to a class of organic compounds containing an ether group, that is an oxygen atom connected to two aliphatic and/or aryl groups and having a general formula R—O—R′, where R and R′ are independently alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “fluorophore” generally refers to a functional group or portion of a compound that causes the compound (or a sample or composition comprising the compound), to fluoresce. In some aspects, the fluorophore can fluoresce when the compound (or a sample or composition comprising the compound) is exposed to an excitation source or after being cleaved from a compound to which the fluorophore is conjugated.

The term “functional group” generally refers to a specific group of atoms within a molecule that is responsible for the characteristic chemical reactions of the molecule. Exemplary functional groups include, without limitation, alkyl, alkenyl, alkynyl, aryl, halo (fluoro, chloro, bromo, iodo), epoxide, hydroxyl, carbonyl (ketone), aldehyde, carbonate ester, carboxylate, carboxyl, ether, ester, peroxy, hydroperoxy, carboxamide, amino (primary, secondary, tertiary), ammonium, imide, azide, cyanate, isocyanate, thiocyanate, nitrate, nitrite, nitrile, nitroalkyl, nitroso, pyridyl, phosphate, sulfonyl, sulfide, thiol (sulfhydryl), disulfide.

The term “halo” generally refers to fluoro, chloro, bromo, or iodo.

The term “heteroaryl” generally refers to an aryl group comprising at least one heteroatom, which can be selected from, but not limited to, oxygen, nitrogen, sulfur, silicon, boron, selenium, phosphorous, and oxidized forms thereof within the ring. Heteroaryl groups can comprise a single ring or multiple condensed rings, wherein the condensed rings may or may not be aromatic and/or contain a heteroatom, provided that the point of attachment is through an atom of the aromatic heteroaryl group. Heteroaryl groups may be substituted with one or more groups other than hydrogen, such as alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality. In some aspects, a fluorophore can also be described herein as a heteroaryl group.

The term “hydroxyl” generally refers to the group —OH.

The term “imine” generally refers to an organic compound containing a —C═NR group, where R is hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “Immunoglobin G (IgG)” generally refers to one of the primary classes of immunoglobins having heavy chains known as gamma-chains.

The term “molecular weight cut-off” (MWCO), generally refers to the lowest molecular weight of sample components that are retained by pores of a solid support matrix, such that lower weight components are retained and higher molecular weight components are excluded, and elute faster.

The term “phosphate” generally refers to —O—P(O)(OR^{a}), wherein each R^{a} independently is hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other organic functional group.

The terms “separation,” “extraction,” “extracted,” “removal,” “reducing” or “reducing the quantity of,” or “purification” generally refer to removing or isolating a substance, e.g., a small molecule, or a large molecule from a mixture comprising the small molecule and/or large molecule. An extracted substance or a sample from which a substance has been extracted has significantly decreased quantities of components that were present in the sample prior to separation, and the extracted substance can be substantially reduced, substantially removed, substantially concentrated, substantially pure, or pure (devoid of any contaminants), compared to prior to being extracted.

The present disclosure uses the terms “small molecule” and “large molecule” to refer to species to be separated from one another. “Small or smaller molecule” generally refers to any molecule having a molecular weight of less than 40,000 Da, and a “large molecule” is a molecule having a molecular weight of greater than or equal to 40,000 Da. Large molecules and/or biomolecules include, for example and without limitation, proteins, glycoproteins, and antibodies. The small molecule (such as but not limited to a biomolecule) may be used to treat, derivatize, conjugate, cross-link, label, tag, chemically or biologically modify the large molecule for further analysis. Derivatization includes labeling molecules with labels such as dyes, affinity tags, radioactive labels, mass tags, metals and the like. Derivatization also includes chemically modifying molecules by reduction, oxidization, methylation, biologically or biochemically modifying biomolecules, etc. Derivatives of biomolecules include, again without limitation: tagged proteins or nucleic acids; labeled biomolecules that are labeled with a variety of labels such as but not limited to dyes, fluorescent dyes, radioactive labels, affinity labels, mass-tags, metals, etc.; conjugated biomolecules, including conjugated antibodies; biomolecules conjugated to nanoparticles; metals, such as gold conjugated to nanoparticles; dyes or labels, such as biotin conjugated to toxins; chemical derivatives of biomolecules, such as but not limited to, reduced proteins, oxidized proteins, methylated nucleic acids, and proteins with sulfhydryl modified proteins.

The term “size exclusion support” generally refers to an inert porous solid that has a porosity which determines the size of a molecule that may be included or excluded from entering the pores. In some disclosed aspects, the pores of a porous size exclusion support have a molecular weight cut-off (MWCO) greater than 30,000 Da.

The term “sulfonamide” generally refers to the group—SO₂amino, —N(R)sulfonyl, where R is hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “sulfonate” generally refers to —SO₃, wherein the negative charge of the sulfonate group may be balanced with a positive counterion, such as an M⁺ counter ion, wherein M⁺ may be an alkali ion, such as K⁺, Na⁺, Li⁺; an ammonium ion, such as +N(R^{b})₄, where R^{b} is hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality; or an alkaline earth ion, such as [Ca²⁺]_{0.5}, [Mg²⁺]_{0.5}, or [Ba²⁺]_{0.5}.

The term “sulfonyl” generally refers a functional group with the general formula:

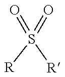

where ‘R an’ R′ independently are selected from hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “thioester” generally refers to a functional group with the general formula:

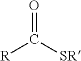

where R and R′ independently are selected from alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality.

The term “thioether” generally refers to a functional group with the general formula: R—S—R′ where R and R′ independently are selected from alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality. A thioether is similar to an ether, except that a thioether contains a sulfur atom in place of the oxygen atom of an ether.

All literature and similar materials cited in this application including, but not limited to, patents, patent applications, articles, books, treatises, and internet web pages, regardless of the format of such literature and similar materials, are expressly incorporated by reference in their entirety for any purpose. In the event that one or more of the incorporated literature and similar materials defines or uses a term in such a way that it contradicts that term's definition in this application, the definitions provided by this specification control. While the present teachings are described in conjunction with various aspect, it is not intended that the present teachings be limited to such aspects. On the contrary, the present teachings encompass various alternatives, modifications, and equivalents, as will be appreciated by a person of ordinary skill in the art in light of the present teachings.

### III. Matrix

Certain disclosed aspects of the present disclosure concern a matrix for separating at least one molecule from another molecule, typically based on molecular weights, and certain aspects may refer to separating a small molecule from at least one large molecule. The matrix may comprise a porous size exclusion support and at least one amine-containing moiety. Each of these components is described in more detail below.

When a sample solution comprising at least one small molecule and at least one large molecule is applied to the matrix, the at least one large molecule is excluded and elutes faster than the small molecule that is trapped by the pores in the porous size exclusion support, thus recoveries should increase as the molecular weight of molecules increase. In some aspects, the at least one amine-containing moiety contributes to the rigidity of the resin, which allows for desired volume recovery and protein recovery in larger spin columns. Presently disclosed matrixes provide unexpectedly rapid, economical, and efficient separation of small molecules from large molecules.

One aspect of the present disclosure describes matrixes for separating, extracting, removing, and/or reducing the quantity of one or more small molecule from one or more large molecules. In some aspect, a sample may comprise at least one or more small molecules having a molecular weight less than 40,000 Da. In some aspects, the small molecule may have a molecular weight ranging from 500 Da to 40,000 Da, such as from 1,000 Da to less than 40,000 Da, 3,000 Da to less than 40,000 Da, 6,000 Da to less than 40,000 Da, 9,000 Da to less than 40,000 Da, 12,000 Da to less than 40,000 Da, 15,000 Da to less than 40,000 Da, 18,000 Da to less than 40,000 Da, 20,000 Da to less than 40,000 Da, 21,000 Da to less than 40,000 Da, 22,000 Da to less than 40,000 Da, 23,000 Da to less than 40,000 Da, 24,000 Da to less than 40,000 Da, 25,000 Da to less than 40,000 Da, 26,000 Da to less than 40,000 Da, 27,000 Da to less than 40,000 Da, 28,000 Da to less than 40,000 Da, 29,000 Da to less than 40,000 Da, 30,000 Da to less than 40,000 Da, 31,000 Da to less than 40,000 Da, 32,000 Da to less than 40,000 Da, 33,000 Da to less than 40,000 Da, 34,000 Da to less than 40,000 Da, 35,000 Da to less than 40,000 Da, 36,000 Da to less than 40,000 Da, 37,000 Da to less than 40,000 Da, 38,000 Da to less than 40,000 Da, or 39,000 Da to less than 40,000 Da.

In some aspects, the one or more small molecules can be a biomolecule or a small molecule used to treat, derivatize, conjugate, cross-link, label, tag, and/or chemically or biologically modify the large molecule for further analysis. In certain aspects, the small molecule can be a biomolecule having a molecular weight less than 40,000 Da. In some aspects, the small molecule can be, but is not limited to, a biomolecule or salt used in treating and/or chemically or biologically modifying one or more large molecules. In particular aspects disclosed herein, the biomolecule can be a protein comprising an aprotinin, ubiquitin, cytochrome C, lactalbumin, trypsin inhibitor, carbonic anhydrase, or any combination thereof.

In particular aspects disclosed herein, the one or more small molecules can be one or more labels such as, but not limited to dyes, affinity tags, radioactive labels, mass tags, metals and the like. In some aspects, the one or more small molecules may comprise a reactive group such as, but not limited to, a hydrophilic group, photoactivatable groups, or groups used to prepare bioconjugates. In certain aspects, the reactive groups include, but are not limited to, olefins, acetylenes, alcohols, phenols, ethers, oxides, halides, aldehydes, ketones, carboxylic acids, esters, amides, cyanates, isocyanates, thiocyanates, isothiocyanates, amines, hydrazines, hydrazones, hydrazides, diazo, diazonium, nitro, nitriles, mercaptans, sulfides, disulfides, sulfoxides, sulfones, sulfonic acids, sulfinic acids, acetals, ketals, anhydrides, sulfates, sulfenic acids isonitriles, amidines, imides, imidates, nitrones, hydroxylamines, oximes, hydroxamic acids thiohydroxamic acids, allenes, ortho esters, sulfites, enamines, ynamines, ureas, pseudoureas, semicarbazides, carbodiimides, carbamates, imines, azides, alkynes (including strained alkynes, such as DIBO and DBCO), azo compounds, azoxy compounds, and nitroso compounds. Reactive functional groups also include those used to prepare bioconjugates, e.g., N-hydroxysuccinimide esters (or succinimidyl esters (SE)), maleimides, sulfodichlorophenyl (SDP) esters, sulfotetrafluorophenyl (STP) esters, tetrafluorophenyl (TFP) esters, pentafluorophenyl (PFP) esters, nitrilotriacetic acids (NTA), aminodextrans, cyclooctyneamines and the like.

In particular aspects, the one or more small molecules can be a dye, which can include rhodamine- and cyanine-based fluorescent dyes, such as, but not limited to, those available from Thermo Fisher Scientific (e.g., ALEXA FLUOR 405, ALEXA FLUOR 488, ALEXA FLUOR 546, ALEXA FLUOR 555, ALEXA FLUOR 568, ALEXA FLUOR 594, ALEXA FLUOR 647, ALEXA FLUOR 680, ALEXA FLUOR 700, DYLIGHT 405, DYLIGHT 488, DYLIGHT 550, DYLIGHT 650) and ATTO-TEC GmbH, Germany (e.g., ATTO 488 and ATT0594).

In some aspects, the large molecule can be a biomolecule having a molecular weight greater than 40,000 Da. In certain aspects, the biomolecule can be, but is not limited to, a protein, a glycoprotein, or an antibody. In some aspects, the biomolecule may have a molecular weight of approximately 42,000 Da, 67,000 Da, 80,000 Da, or 150,000 Da. In some exemplary aspect, the biomolecule can be protein comprising ovalbumin, transferrin, protein A, bovine serum albumin (BSA), immunoglobin G (IgG), or any combination thereof.

### A. Size Exclusion Support

Matrixes according to the present disclosure may comprise a porous size exclusion support. The pore size range of a porous size exclusion support determines the size of a molecule that may be included or excluded from the porous size exclusion support. Without being bound by this theory, when a sample solution is passed through a porous size exclusion support, molecules having a molecular weight less than the molecular weight cut-off (MWCO) are forced to follow a circuitous path before later exiting the porous size exclusion support. On the other hand, large molecules take a relatively direct path through the porous size exclusion support. Therefore, the difference in flow rates between the small molecules and large molecules allows for the separation of the faster-flowing large molecules from the slower-flowing small molecules as a sample travel through the size exclusion support.

In certain aspects, the matrix may comprise a porous size exclusion support may comprise spherical beads made of a gel or a gel-like material having pores. In some aspects, the porous size exclusion support may comprise agarose, polyacrylamide, a dextran, cellulosic materials, such as 2-hydroxyethyl cellulose, and derivatives thereof, a chemically modified cellulose, a cyclodextrin (such as p-cyclodextrin), and combinations thereof.

The porous size exclusion support may be modified by one or more modifying reagents and/or crosslinked with at least one crosslinker. In certain aspects, the crosslinker or the one more modifying reagents can be a heterocyclic compound having Formula I, Formula II, or Formula III

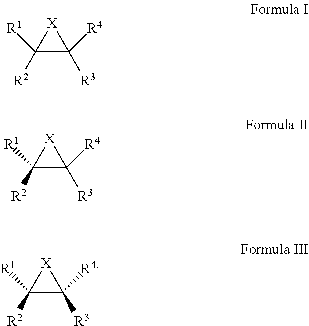

wherein X is a heteroatom selected from nitrogen, oxygen, or sulfur; and R¹-R⁴ are independently hydrogen or aliphatic, heteroaliphatic, or haloaliphatic. R¹-R⁴ are more typically alkyl, heteroalkyl, haloalkyl, halo, or glycidyl ether.

In some aspects, when X is sulfur, the heterocyclic compound can be episulfide

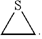

In other aspects disclosed herein, when X is oxygen, the heterocyclic compound can be an epoxyalkane from C₂-C₁₀. In one exemplary aspect, the epoxyalkane is epoxybutane. In another exemplary aspect, the epoxyalkane is epoxyhexane. In yet another aspect, the epoxyalkane is epoxypropane.

In some aspects disclosed herein, when X is oxygen, the heterocyclic compound can be an epoxide having Formula IV

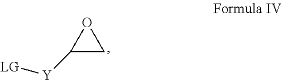

wherein Y is a C₁-C₁₀ alkyl; and LG can be any suitable leaving group. In certain aspects, LG is a halogen (F, Cl, Br, I), a positively charged tertiary amine, or a glycidol moiety. In one exemplary aspect,
the epoxide is epichlorohydrin

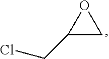

which may be referred to as “Epi” herein. In another exemplary aspect, the epoxide is diglycidyl ether

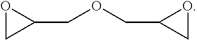

In some aspects, when X is nitrogen, the heterocyclic compound can be aziridine

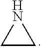

Similarly, in another exemplary aspect, the heterocyclic compound can be diazirine

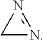

In other aspects disclosed herein, the one or more modifying reagents and/or crosslinker can be a sulfide compound. In some aspects, the sulfide compound can be a thiol, sulfide, disulfide, thioester, sulfoxide, or sulfonyl. In one exemplary aspect, the sulfide compound is disulfide R—S—S—R′, wherein R and R′ are independently hydrogen, alkyl, heteroalkyl, haloalkyl, aliphatic, heteroaliphatic, haloaliphatic, aryl (such as optionally substituted phenyl or benzyl), heteroaryl, haloaryl, alkylsulfano, or other functionality, wherein in more particular the alkyl groups are from C₁-C₁₀. In another exemplary aspect, the sulfonyl compound is dimethyl sulfate

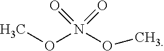

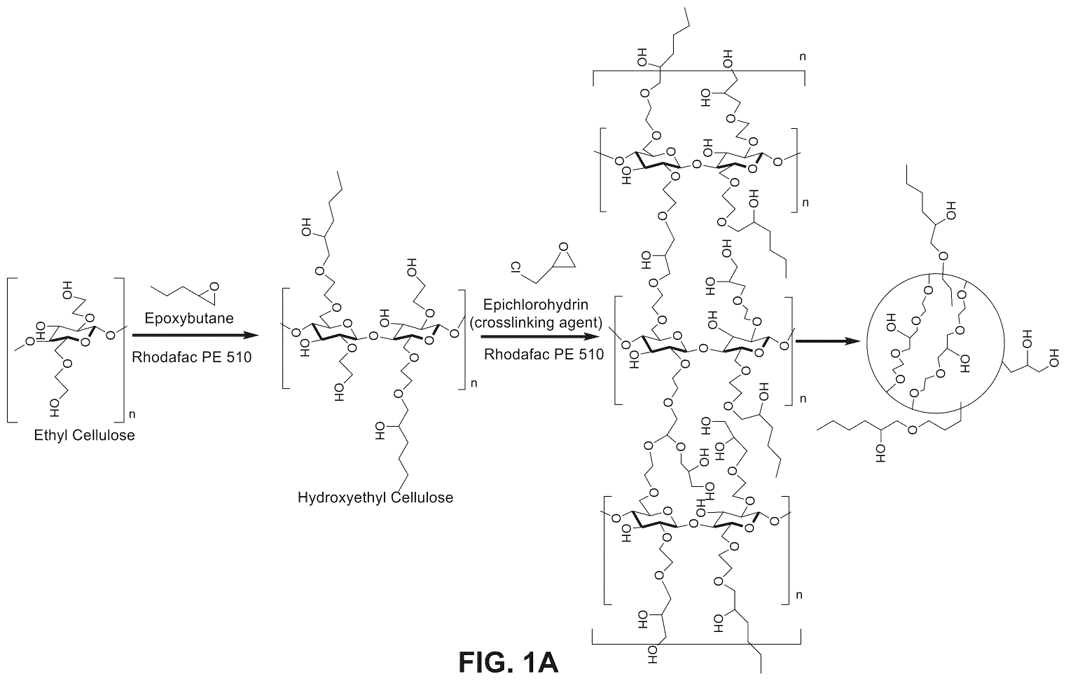

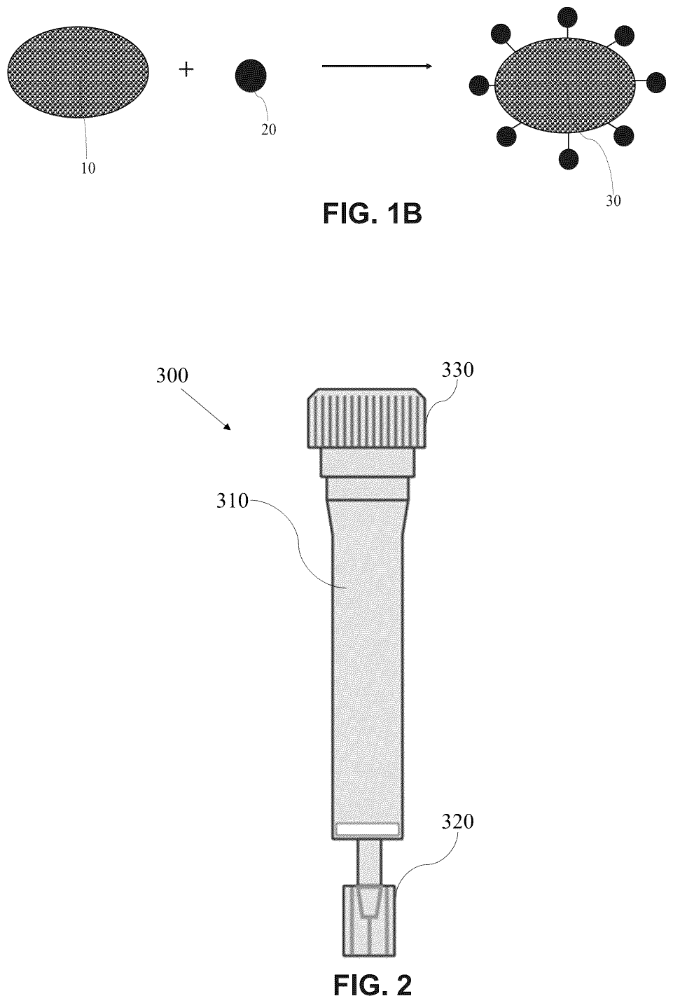

In some aspects, the porous size exclusion support is modified with the one or more modifying reagents prior to crosslinking. For example, FIG. 1A illustrates one exemplary aspect, wherein a porous size exclusion support comprising 2-hydroxyethyl cellulose is modified with epoxybutane prior to crosslinking.

In some aspects, HEC is crosslinked with Epi and is not modified with a modifying reagent as illustrated in Scheme 1. With reference to Scheme 1 and without being bound by this theory, the emulsion formed and the resulting crosslinking reaction control the formation of the resin beads.

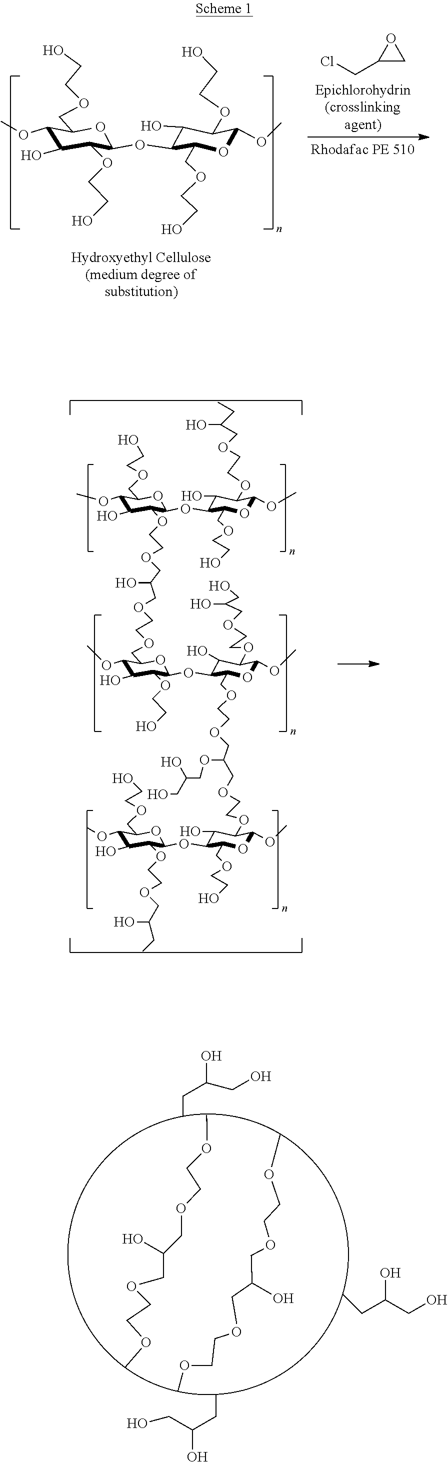

Disclosed aspects of the porous size exclusion support may comprise the products formed by reacting from greater than 0 kg to 25 kg of 2-hydroxyethyl cellulose in the presence of base with from greater than 0 to 50 L of Epi crosslinker in the presence of a non-polar phase containing solvent and a surfactant. In some aspects, the ratio of HEC: Epi used to make the porous size exclusion support can be from 0.3 to 0.75. In certain aspects, the ratio of HEC: Epi used to make the porous size exclusion support can be 0.49, 0.32, or 0.66. In one exemplary aspect, the porous size exclusion support may comprise the products formed by reacting 129 g of 2-hydroxyethyl cellulose with 265 mL of epichlorohydrin. In another exemplary aspect, the porous size exclusion support may comprise the products formed by reacting 129 g of 2-hydroxyethyl cellulose with 397 mL of epichlorohydrin. In yet another exemplary aspect, 19 kg of 2-hydroxyethyl cellulose were reacted with 29 L of epichlorohydrin.

In certain aspects, a comparator, herein referred to interchangeably as a “comparative resin” or “Resin A” was produced as described in the Examples (see Section VIII), by reacting 173 grams (g) of 2-hydroxyethyl cellulose (HEC) in the presence of base with 265 mL (milliliter) of epichlorohydrin crosslinker in the presence of a non-polar phase containing solvent and a surfactant (i.e., nonionic detergent). In some aspects, disclosed porous size exclusion supports may comprise HEC ranging from 0% to about 30% less HEC than is used for the comparative Resin A, including ranges in between, such as but not limited to, 0% less or 25% less HEC than is used in Resin A.

In some disclosed aspects, the porous size exclusion support is a crosslinked support, such as support material crosslinked with Epi. In some aspects, disclosed size exclusion supports are made using an equal amount of Epi to approximately a 70% increase in Epi compared to Resin A, including ranges in between, such as but not limited to, 0% more or 50% more Epi compared to porous size exclusion support of Resin A. In some aspects, disclosed size exclusion supports are made using an equal amount of Epi to approximately 25% less epichlorohydrin than the comparative resin, including ranges in between, such as but not limited to, 0% or 25% less Epi.

In some aspects, the reaction forming the porous size exclusion support can be facilitated using a surfactant. In some aspects, the surfactant may comprise a non-ionic detergent, for example, the non-ionic detergent sold under the trademark Rhodofac-PE-510 and similar variations thereof.

In some aspects, the porous size exclusion support has a MWCO greater than 30,000 Da, and hence the pore size of the size exclusion support may exclude (from the pores) molecules of about 30,000 Da to about 45,000 Da, more typically from about 35,000 Da to about 43,000 Da, and even more typically from about 33,000 Da to about 41,000 Da. A person of ordinary skill in the art will understand that these size ranges include MWCO in between, such as but not limited to, 30,000 Da, 31,000 Da, 32,000 Da, 33,000 Da, 34,000 Da, 35,000 Da, 36,000 Da, 37,000 Da, 38,000 Da, 39,000 Da, 40,000 Da, 41,000 Da, 42,000 Da, 43,000 Da, 44,000 Da, 45,000 Da. In some aspects, there is no upper limit for the protein size that can be excluded, and mega Dalton size molecules also can be separated from small molecule impurities or contaminants by a matrix, system, kit, or method according to the present disclosure.

### B. Post Modification

Disclosed matrixes may comprise a porous size exclusion support modified with at least one amine-containing moiety. In some aspects, a matrix of the disclosure comprises at least one amine-containing moiety that is operatively associated with at least one size exclusion support (referred to herein as post modification).

In some aspects, prior to association with the porous size exclusion support, the amine-containing moiety is a monoamine, diamine, or a polyamine. In some aspects, prior to association with the porous size exclusion support, the amine-containing moiety is an amine salt, such as an amine-based hydrochloride salt, an amine-based citrate salt, an amine-based sulfate salt or other salts, including monohydrochloride and/or dihydrochloride salts.

In some aspects, the amine-containing moiety can be, prior to modifying the support material, represented by Formula V or a salt thereof

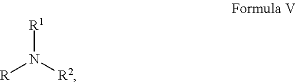

where at least one of R, R¹ and R² is hydrogen, at least one of R, R¹ and R² is aliphatic, heteroaliphatic, aryl, or heteroaryl, and remaining R, R¹ and R² are independently hydrogen, aliphatic, heteroaliphatic, aryl, or heteroaryl, and the like. In some aspects, at least one of R, R¹ and R² is hydrogen, and remaining R, R¹ and R² groups are independently C₁-C₁₀ aliphatic. In some aspects, at least one of R, R¹ and R² is hydrogen, and remaining R, R¹ and R² groups are methyl, ethyl, propyl, isopropyl, butyl, sec-butyl, tertiary butyl, pentyl, isopentyl, hexyl, or isohexyl, and the like. In an exemplary aspect, at least one of R, R¹ and R² is butyl, and hence the amine-containing moiety is butylamine,

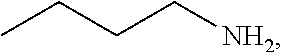

or a salt thereof.

In some aspects, the at least one amine-containing moiety is a diamine or a polyamine, such as a diamine represented by Formula VI or a salt thereof

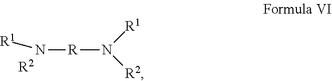

where R is aliphatic, heteroaliphatic, aryl, or heteroaryl, at least one of R¹, R², R³ and R⁴ is hydrogen, and remaining R¹, R², R³ and R⁴ are independently hydrogen, aliphatic, heteroaliphatic, aryl, heteroaryl, and the like. Typically, at least one or more of R¹, R², R³ and R⁴ are hydrogen. In some aspects, R is independently C₁-C₁₀ aliphatic.

In certain aspects, the amine is a primary amine having Formula VII or a salt thereof

H₂N—R—NH₂ Formula VII,

where R is aliphatic, heteroaliphatic, aryl, or heteroaryl. In some aspects, R is independently C₁-C₁₀ aliphatic. In an exemplary aspect, the amine-containing moiety is 1,5-diaminopentane (PDA), a five-carbon diamine having formula

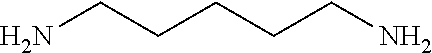

or a salt thereof. In another exemplary aspect, the amine-containing moiety is hexamethylenediamine dihydrochloride salt.

In some aspects, the amine-containing moiety can have a Formula VIII or a salt thereof

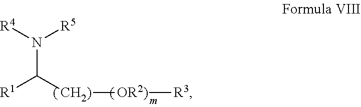

where R¹ is hydrogen, aliphatic, heteroaliphatic, aryl, or heteroaryl, R² and R³ are independently aliphatic, heteroaliphatic, aryl, or heteroaryl, and the like; at least one of R⁴ and R⁵ is hydrogen, and remaining R⁴ and R⁵ groups are independently hydrogen, aliphatic, heteroaliphatic, aryl, or heteroaryl, and the like. The “m” and “n” variables in Formula VIII are integers from 1 to 10. In another exemplary aspect, the amine-containing moiety is O-(2-Aminopropyl)-O′-(2-methoxyethyl)polypropylene glycol (MJ), also known commercially as Jeffamine® M-600, having formula,

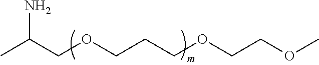

(also referred to as 2,5,9,13-tetraoxahexadecan-15-amine when “m” is 2), or a salt thereof.

In particular disclosed aspects, the modification reagents disclosed herein may be used to in the post modification of the matrix.

In some aspects, the method of immobilizing the amine-containing moiety onto the porous size exclusion support comprises adding a reagent comprising the amine-containing moiety per milliliter of the porous size exclusion support, can be in the range of from greater than 0 mg/mL to 55 mg/mL. In some aspects, the concentration of the reagent per milliliter of the porous size exclusion support bed (settled resin bed per volume) may comprise 0.5 mg/mL, 1 mg/mL, 1.5 mg/mL, 2.0 mg/mL, 2.5 mg/mL, 3.0 mg/mL, 3.5 mg/mL, 4.0 mg/mL, 4.5 mg/mL, 5.0 mg/mL, 5.5 mg/mL, 6.0 mg/mL, 6.5 mg/mL, 7.0 mg mg/mL 7.5 mg/mL, 8.0 mg/mL, 8.5 mg/mL, 9.0 mg/mL, 9.5 mg/mL, 10 mg/mL, 15 mg/mL, 20 mg/mL, 30 mg/mL, 40 mg/mL, 50 mg/mL, or 55 mg/mL. In preferred aspects, the concentration of the reagent per milliliter of the porous size exclusion support bed (settled resin bed per volume) is from greater than 0 mg/mL to 10 mg/mL, such as from 0.5 mg/mL, 1 mg/mL, 1.5 mg/mL, 2.0 mg/mL, 2.5 mg/mL, 3.0 mg/mL, 3.5 mg/mL, 4.0 mg/mL, 4.5 mg/mL, 5.0 mg/mL, 5.5 mg/mL, 6.0 mg/mL, 6.5 mg/mL, 7.0 mg mg/mL 7.5 mg/mL, 8.0 mg/mL, 8.5 mg/mL, 9.0 mg/mL, 9.5 mg/mL, or 10 mg/mL.

In some aspects, a matrix of the disclosure comprises at least one amine-containing moiety that is operatively associated with at least one size exclusion support (referred to herein as post modification). For example, the at least one amine-containing moiety can be covalently bonded to the porous size exclusion support by formation of a covalent bond, such as but not limited to, alkylation or by forming an amide or amine bond between a porous size exclusion support and the at least one amine-containing moiety. In an exemplary aspect, with reference to Scheme 2 and without being bound by a particular theory, immobilization according to the disclosure is achieved by oxidizing hydroxyl groups provided by HEC to produce aldehyde groups. HEC can be oxidized to generate aldehyde groups using any suitable oxidizing agent, such as periodate (IO⁴⁻ or IO₆⁵⁻). The aldehyde groups generated by oxidation can react with amines on an amine-containing moiety to covalently bind the amine-containing moiety to the HEC support as an imine, and the resulting intermediate may be reduced using reagents such as sodium cyanoborohydride, picoline borane, or an amine borane to form an amine such as triethylamine borane.

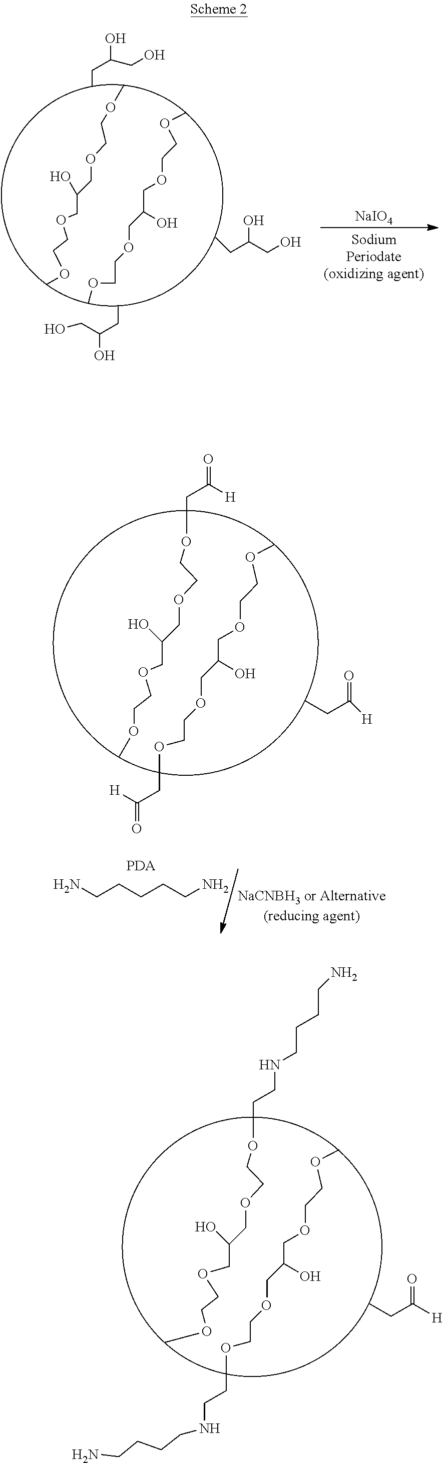

In some aspects, a matrix of the disclosure comprises at least one amine-containing moiety that is associated with at least one porous size exclusion support. In some aspects, either a porous size exclusion support or at least one amine-containing moiety can include a reactive functional group to facilitate forming a rigid matrix structure allowing for use in larger columns. Any suitable functional group can be used including, but not limited to, hydroxyl, carboxyl, amino, thiol, aldehyde, halogen, nitro, cyano amido, urea, carbonate, carbamate, isocyanate, sulfone, sulfonate, sulfonamide, sulfoxide, etc.

In another aspect, functional groups include at least one reactive group represented by either Rₓ, which represents a reactive functional moiety, or (-L-Rₓ), which represents a reactive functional moiety Rₓ that is attached to either a porous size exclusion support or a moiety by a covalent linker L. The reactive group functions as the site of association, attachment and/or interaction. In an exemplary aspect, a reactive group or a functional group can be an acrylamide, an activated ester of a carboxylic acid, an acyl halide group, an acyl azide, an acyl nitrile, an aldehyde, an alkyl halide, an anhydride, an aniline, an aryl halide, an azide, an aziridine, a boronate, a thioboronate group, a carboxylic acid, a diazoalkane, a haloacetamide, a halotriazine, a hydrazine, a hydrazide, an imido ester, an isocyanate, an isothiocyanate, a maleimide, a phosphoramidite, a sulfonyl halide, a thiol group, a sulfide group, a disulfide group, an epoxide group, and episulfide group, a thioester group, an alcohol group, an activated alcohol group, a phosphate group, a phosphate ester group, and a photoactivatable group.

In another exemplary aspect, a reactive group or functional group can comprise electrophiles and/or nucleophiles and can in some aspects generate a covalent linkage between them. Exemplary electrophiles and nucleophile functional groups can include activated esters, generally having the formula —COΩ, where Ω is a good leaving group (e.g. oxysuccinimidyl (—OC₄H₄O₂) oxysulfosuccinimidyl (—OC₄H₃O₂— SO₃H), −1-oxybenzotriazolyl (—OC₆H N₃); or an aryloxy group or aryloxy substituted one or more times by electron withdrawing substituents such as nitro, fluoro, chloro, cyano, or trifluoromethyl, or combinations thereof, used to form activated aryl esters; or a carboxylic acid activated by a carbodiimide to form an anhydride or mixed anhydride —OCOR^{a} or —OCNR^{a}NHR^{b}, where R^{a} and R^{b} may be the same or different, and typically are C₁-C₆ alkyl, CᵣC₆ perfluoroalkyl, or C₁-C₆ alkoxy; or cyclohexyl, 3-dimethylaminopropyl, an acyl halide group, an acyl nitrile, an aldehyde, an alkyl halide, an anhydride, an aryl halide, an aziridine, a diazoalkane, a haloacetamide, a halotriazine, an isocyanate, an isothiocyanate, a maleimide, a phosphoramidite, a sulfonyl halide, a sulfide group, a disulfide group, an epoxide group, and episulfide group, a thioester group, an activated alcohol group, a phosphate group, a phosphate ester group, or a photoactivatable group. Acyl azides can also rearrange to isocyanates.

The linker L can be used to covalently attach a reactive functional group. When present, the linker comprises from 1 to 15 nonhydrogen atoms and may include one or more of an ether, thioether, thiourea, amine, ester, carboxamide, sulfonamide, hydrazide bonds and aromatic or heteroaromatic bonds. The linker is a single covalent bond or a series of stable bonds. A reactive functional moiety may be directly attached (where the linker is a single bond) through a series of stable bonds, to the porous size exclusion support or the amine-containing moiety. When the linker is a series of stable covalent bonds the linker typically incorporates several nonhydrogen atoms selected from the group consisting of C, N, O, S, Si, B and P. In addition, the covalent linkage can incorporate a platinum atom, such as described in U.S. Pat. No. 5,714,327, the relevant portion of which is incorporated herein by reference. When the linker is not a single covalent bond, the linker may be any combination of stable chemical bonds, optionally including, single, double, triple, or aromatic carbon-carbon bonds, as well as carbon-nitrogen bonds, nitrogen-nitrogen bonds, carbon-oxygen bonds, sulfur-sulfur bonds, carbon-sulfur bonds, phosphorus-oxygen bonds, phosphorus-nitrogen bonds, and nitrogen-platinum bonds. Typically, the linker is a single covalent bond or a combination of single carbon-carbon bonds and carboxamide, sulfonamide or thioether bonds. The following moieties can be found in the linker: ether, thioether, carboxamide, thiourea, sulfonamide, urea, urethane, hydrazine, alkyl, aryl, heteroaryl, alkoxy, cycloalkyl and amine moieties. Examples of L include substituted or unsubstituted polymethylene, arylene, alkylarylene, arylenealkyl, or arylthiol.

In some aspects, a matrix of the present disclosure (when contacted with a sample) substantially reduces the quantity of the one or more small molecules from the sample. In some aspects, contacting a sample with a matrix of the disclosure comprises without limitation one or more of the following: applying a sample onto the composition, passing the sample through the composition, allowing a sample to flow through the composition by gravity or by using a rotary or a centrifugal force, creating a pressure differential to cause sample to move through the matrix.

FIG. 1B is a schematic illustration of an exemplary aspect comprising associating a porous size exclusion support 110 with an amine-containing moiety 120 to form a modified support 130. The porous-size exclusion support 110 can be any suitable support as disclosed herein such as, by way of example, a support comprising 25% less HEC than the comparator (129 grams HEC versus 173 grams HEC used in Resin A). Similarly, the amine-containing moiety 120 can be any suitable disclosed moiety, such as PDA or MJ. Matrix 130 can be tailored to have a desired MWCO, such as a MWCO of 40,000 Da with rigid properties. Modified supports 130 have optimal protein and volume recovery and allow for the matrix to be used in larger sized spin columns. For example, from 5 mL to 50 mL spin columns, such as from 5 mL, 10 mL, 15 mL, 20 mL, 25 mL, 30 mL, 35 mL, 40 mL, 45 mL, 50 mL.

The present disclosure compares fluid flow through 10 mL columns, with a first column comprising a non-modified support comprising Resin A compared to a second column comprising a modified support according to the present disclosure. Fluid flow through a matrix comprising a modified porous size exclusion support comprising 2-hydroxyethyl cellulose crosslinked with epichlorohydrin and modified with PDA has superior fluid flow properties compared to a 10 mL column of Resin A, which had comparatively poor drainage.

### IV. System

The present disclosure also concerns systems comprising one or more disclosed matrixes and further comprising a container. Such systems provide one or more advantages, including: economical; simple and easy to use; provide faster results relative to products known prior to the present disclosure; are adaptable as a single use disposable unit; can be adapted for high throughput sample preparation in multi-well container formats; and can be adapted to automated and robotic sample preparation systems. Reducing the concentration of small molecules in a sample using the systems provided here provides quick recovery of biomolecules, as well as superior purity of biomolecules and their derivatives that can be used for downstream applications.

In some aspects, the present disclosure provides a system for removing one or more small molecules from a sample, wherein the system comprises: a container having at least one size exclusion support and at least one amine-containing moiety that can associate with the one or more small molecules; and a receptacle located to receive flow from the container. In some disclosed system aspects, the receptacle is attached to the column. In some aspects, the receptacle is detachable from the column. The contents of a receptacle can be used or removed by a user as desired. In some aspects, the receptacle collects sample with substantially reduced concentrations of small molecules. In some aspects, the receptacle collects sample with no small molecules.

The system may be operably configured to operate by gravity flow. Alternatively, an external, affirmatively-applied pressure or force can be applied to facilitate flow, such as a centrifugal force, a positive pressure, a negative pressure, vacuum, or combinations thereof. Structures that allow applications of the above-mentioned pressures or forces include, without limitation: a syringe that can be drawn to cause a positive pressure; a vacuum frit for generating negative pressure; and/or tubes or containers adaptable to commercially available centrifuges or rotatory devices. In some aspects, the system can be configured for use with or in a centrifuge tube or any other comparable rotary instrument.

In some disclosed system aspects, the container is a columnar container, a tube, a multi-well tube, a multi-well plate or a multi-well filter plate. FIG. 2 depicts an exemplary separation system 300 according to one aspect of the present disclosure. System 300 comprises: a container 310 (such as a columnar tube, a test-tube or a spin column); matrix (not shown) housed by the container 310; a receptacle 320 located below the container 310 that is adaptable or configured to receive fluid flowing through the container 310 through its bottom end. In some aspects, the container 310 may also comprise one or more frits (not depicted). In some aspects, system 300 can include an optional lid 330 that can be used to secure container 310 at a top end. In some aspects, the receptacle 320 can be detached from container 310 so that a user can collect the flow-through. In some aspects, receptacle 320 has a twist-off tab configuration for removal. In other aspects, a receptacle 320 can be threadedly coupled to container 310 or attached using a complementary fit that can be pulled apart, and the like. Exemplary containers may include, but are not limited to, a test tube, a spin column, a multi-well plate, a multi-well filter plate, a micro-well plate, or a micro-well filter plate. In some disclosed system aspects, the spin column can have a volume in the range of 0.005 mL (5 μL) to 50 mL. In some exemplary aspects, the spin column can have a volume of 0.075 mL (75 μL), 2 mL, 5 mL, or 10 mL, 15 mL, 20 mL, 25 mL, 30 mL, 35 mL, 40 mL, 45 mL, or 50 mL.

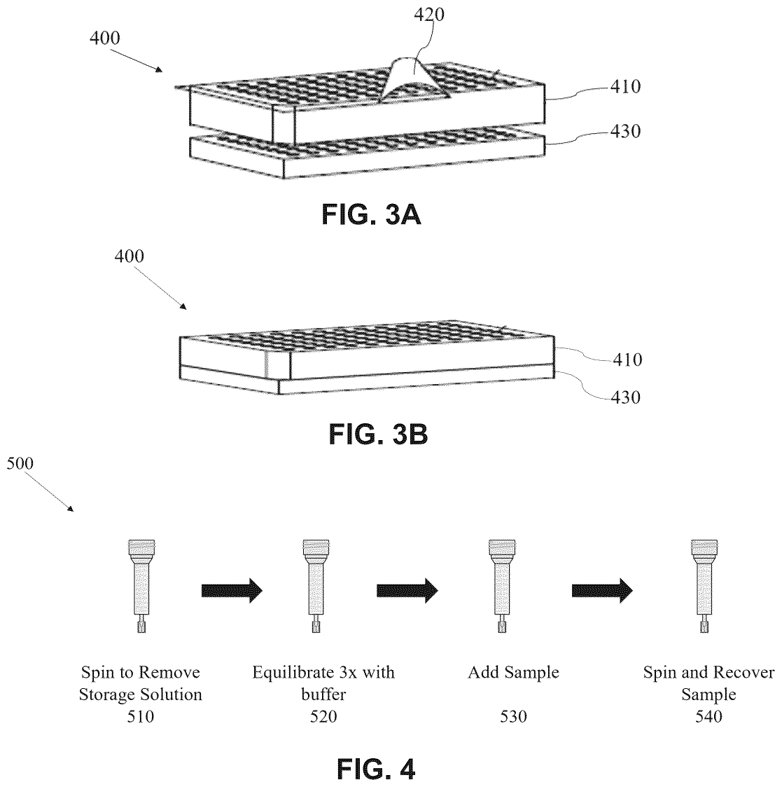

FIGS. 3A-3B depict an exemplary system 400 according to one aspect of the present disclosure comprising a multi-well container 410. Multi-well container 410 comprises a wall that defines multiple wells. Multi-well container 410 houses a matrix comprising at least one porous size exclusion support and at least one amine-containing moiety according to the present disclosure. As illustrated by FIGS. 3A-3B, the multi-well container may comprise an optional container lid 420. Lid 420 can be any suitable removable/detachable structure, such as a foil, a clear wrap, or a tear-off seal. Multi-well container 410 can be a multi-well plate, a multi-well plate filter, a microplate or a microtiter plate comprising a flat plate comprising multiple wells where each well is used as a small test tube or container. Multi-well plates come in a variety of formats for high throughput use and may comprise 6, 12, 24, 48, 96, 384, 1536, 3456, 9600 or more wells arranged in a rectangular matrix or array. The system 400 comprises a receptacle 430 located below the multi-well container 410 that is adaptable or configured to receive fluid flowing from the container. In some aspects, receptacle 430 may comprise a multi-well tray to collect flow through. Receptacle 430 may be detachable and can be collected by a user. In some aspects, receptacle 430 is a wash plate or a collection plate.

Systems according to the present disclosure may be fully automated or may be manually operated systems. In some aspects, a system may be operated in part manually and in-part by automation.

A system can also comprise a computer system comprising a CPU, hardware elements, and/or software elements. Suitable computer systems may be operable to control various components of the system, such as a control robot to retrieve flow through and analyze flow through. In some aspects, a computer system and/or components thereof may reside physically within system 300 or 400 may reside externally. A computer system used herein may comprise a data analysis and control system, a data transfer system such as a read-write CD ROM Drive or DVD drive, at least one USB port, and/or at least one Ethernet port. In some aspects, a computer system may include pre-loaded software and/or Application Specific Integrated Circuits (ASICS) to control disclosed systems, such as systems 300, 400, and/or other components the system, including sample processing and analysis, display, and/or exporting the results.

Disclosed system aspects also may optionally comprise one or more devices or components operable to further process flow through. In some aspects, the flow through can be eluted biomolecules, such as but not limited to, eluted derivatized proteins, such as tagged proteins for fluorescent detection or immunoassays. In some aspects, a system may comprise an imager or a protein or a nucleic acid detector or sequencer.

A system may also comprise additional devices or components, such as but not limited to, a power supply, a display unit, such as a monitor operable to view sample processing and/or to monitor extraction of biomolecules from samples; spectrophotometers; devices to measure nucleic acid extraction; devices to further process extracted biomolecules for further analysis; printers and the like. A system of the disclosure may be configured to fit on a laboratory bench top.

### V. Method of Making

Aspects of the present disclosure also concern a method for making a matrix or a system according to the present disclosure. In some aspects, the method of making comprises modifying the porous size exclusion support via immobilizing an amine-containing moiety to a porous size exclusion support.

A porous size exclusion support may comprise spherical beads made of a gel or a gel-like material having pores. Some exemplary size exclusion supports comprise agarose, polyacrylamide, cellulosic materials, such as 2-hydroxyethyl cellulose, and derivatives thereof. The porous size exclusion support may be crosslinked with at least one crosslinker. Additionally, in some aspects, the porous size exclusion comprising 2-hydroxyethyl cellulose and epichlorohydrin, the porous size exclusion support can be further crosslinked with a crosslinker described herein prior to the addition of the amine-containing moiety. The pore size range of a porous size exclusion support determines the size of a molecule that may be included or excluded from entering the porous size exclusion support. Without being bound by this theory, when a sample solution is passed through a porous size exclusion support molecules having a molecular weight less than or substantially equal to the MWCO are forced to follow a circuitous path before later exiting the porous size exclusion support. On the other hand, large molecules take a relatively direct path through the porous size exclusion support. Therefore, the difference in flow rates between the small molecules and large molecules allows for the separation of the faster-flowing large molecules from the slower-flowing small molecules as a sample travel through the size exclusion support.

In some aspects, the porous size exclusion support may be modified by one or more modifying reagents and/or crosslinked with a crosslinker as previously discussed. In certain aspects, the porous size exclusion support is modified with the one or more modifying reagents prior to crosslinking with a crosslinking. For example, FIG. 1A illustrated an aspect wherein a porous size exclusion support comprising 2-hydroxyethyl cellulose is modified with epoxybutane prior to crosslinking with Epi.

In certain aspects, 2-hydroxyethyl cellulose is not modified with a modifying reagent but is crosslinked with a crosslinker. Disclosed aspects of the porous size exclusion support may comprise the products formed by reacting from greater than 0 kg to 25 kg of 2-hydroxyethyl cellulose in the presence of base with from greater than 0 L to 50 L of epichlorohydrin crosslinker in the presence of a non-polar phase containing solvent, wherein the non-polar phases are brought together and reacted via a surfactant comprising a non-ionic detergent. In one exemplary aspect, the porous size exclusion support may comprise the products formed by reacting 129 g of 2-hydroxyethyl cellulose with 265 mL of epichlorohydrin. In another exemplary aspect, the porous size exclusion support may comprise the products formed by reacting 129 g of 2-hydroxyethyl cellulose with 397 mL of epichlorohydrin. Thus, without being bound by this theory, the emulsion formed, and the resulting crosslinking reaction controls the formation of the resin beads.

In some aspects, disclosed size exclusion supports are made using an equal amount of epichlorohydrin to approximately a 70% increase in epichlorohydrin compared to a porous size exclusion support of Resin A, including ranges in between, such as but not limited to, 0% more or 50% more epichlorohydrin compared to Resin A.

In some aspects, disclosed size exclusion supports are made using an equal amount of epichlorohydrin to approximately 25% less epichlorohydrin than is used for porous size exclusion support of Resin A, including ranges in between, such as but not limited to, 0% or 25% less epichlorohydrin.

In some aspects, the porous size exclusion support is an epichlorohydrin crosslinked support, further comprising an epoxide compound. In some aspects, the porous size exclusion support further comprises an aliphatic epoxide. In an exemplary aspect, the porous size exclusion support further comprises epoxybutane, CH₃CH(O)CHCH₃.

In some aspects, the porous size exclusion support is prepared with a surfactant. In an exemplary aspect, the surfactant is the nonionic detergent, known commercially as Rhodafac-PE-510.

In some aspects, the porous size exclusion support has a MWCO greater than 30,000 Da and hence molecules that are excluded have a molecular weight of 30,000 Da or greater. In certain aspects, the pore size of the size exclusion support may have a MWCO for excluding from the pores molecules of about 30,000 Da to about 45,000 Da, more typically from about 37,000 Da to about 43,000 Da, and even more typically from about 39,000 Da to about 41,000 Da, including MWCO in between, such as but not limited to, 30,000 Da, 36,000 Da, 37,000 Da, 38,000 Da, 39,000 Da, 40,000 Da, 41,000 Da, 42,000 Da, 43,000 Da, 44,000 Da, and 45,000 Da. In some aspects, there is no upper limit for the size of proteins that can be excluded, and mega Dalton size molecules also can be separated from small molecule impurities or contaminants by a matrix, system, kit or method according to the present disclosure.

In some aspects, the amine-containing moiety is immobilized to the porous size exclusion support by formation of a covalent bond such as, but not limited to, amidation, alkylation, amination, or other covalent bond forming procedure. For example, the size exclusion support may be oxidized, such as by using periodate, to generate an aldehyde. These generated aldehyde groups can react with amines on the amine-containing moiety to form an imine intermediate that is chemically reduced to form an amine. Any suitable oxidation reagent, in suitable amounts, as will be understood by a person of ordinary skill in the art can be used to oxidize the support material, such as 2-hydroxyethyl cellulose. In some aspects, the size exclusion support is oxidized using sodium periodate. In some aspects, 5 mg/mL to 35 mg/mL of the oxidation agent, such as periodate, is added to oxidize the porous size exclusion support resin bed. In some aspects, 5 mg/mL, 10 mg/mL 15 mg/mL, 16 mg/mL, 17 mg/mL, 18 mg/mL, 19 mg/mL, 20 mg/mL 21 mg/mL, 22 mg/mL 23 mg/mL, 24 mg/mL, 25 mg/mL, 26 mg/mL, 27 mg/mL, 28 mg/mL, 29 mg/mL, 30 mg/mL, 31 mg/mL, 32 mg/mL, 33 mg/mL, 34 mg/mL, or 35 mg/mL of sodium periodate is added to oxidize the porous size exclusion support resin bed.

Certain disclosed aspects use reductive amination to couple an amine-containing moiety to the support material. The amine-containing moiety can be any suitable moiety as discussed above. Exemplary reducing agents include sodium cyanoborohydride, picoline borane, or amine borane such as triethylamine borane. In some aspects, 5-15 mg/mL of a reducing agent is added. In some aspects, 5 mg/mL, 6 mg/mL, 7 mg/mL, 8 mg/mL, 9 mg/mL, 10 mg/mL, 11 mg/mL, 12 mg/mL, 13 mg/mL, 14 mg/mL, 15 mg/mL of the reducing agent is added.

In some aspects, the method of immobilizing the amine-containing moiety onto the porous size exclusion support comprises adding a reagent comprising the amine-containing moiety in milligrams per milliliter of the porous size exclusion support (settled resin bed per volume) can be in the range of from greater than 0 mg/mL to 55 mg/mL. In some aspects, the reagent comprising the amine-containing moiety per milliliter of the porous size exclusion support bed may comprise 0.5 mg/mL, 1 mg/mL, 1.5 mg/mL, 2.0 mg/mL, 2.5 mg/mL, 3.0 mg/mL, 3.5 mg/mL, 4.0 mg/mL, 4.5 mg/mL, 5.0 mg/mL, 5.5 mg/mL, 6.0 mg/mL, 6.5 mg/mL, 7.0 mg mg/mL 7.5 mg/mL, 8.0 mg/mL, 8.5 mg/mL, 9.0 mg/mL, 9.5 mg/mL, 10 mg/mL, 15 mg/mL, 20 mg/mL, 30 mg/mL, 40 mg/mL, 50 mg/mL, or 55 mg/mL. In preferred aspects, the reagent comprising the amine-containing moiety per milliliter of the porous size exclusion support bed may comprise 0.5 mg/mL, 1 mg/mL, 1.5 mg/mL, 2.0 mg/mL, 2.5 mg/mL, 3.0 mg/mL, 3.5 mg/mL, 4.0 mg/mL, 4.5 mg/mL, 5.0 mg/mL, 5.5 mg/mL, 6.0 mg/mL, 6.5 mg/mL, 7.0 mg mg/mL 7.5 mg/mL, 8.0 mg/mL, 8.5 mg/mL, 9.0 mg/mL, 9.5 mg/mL, or 10 mg/mL.

In an exemplary aspect, sodium metaperiodate is dissolved in water and is mixed with 2-hydroxyethyl cellulose porous size exclusion support material to oxidize vicinal diols present in the HEC to aldehyde groups. The mixture is allowed to react for a suitable time period, such as from about 2 to about 4 hours, at a temperature in the range of about 15° C. to about 30° C. In an exemplary aspect, the mixture is allowed to react for at least four hours at room temperature with constant overhead stirring. In some aspects, during the reductive amination step (i.e., reacting the amine group on the amine-containing moiety with the aldehyde groups on size exclusion support matrix bed and reducing intermediate imines to amines) the amine-containing moiety is prepared at a pH from about 8.0 to about 8.5 and is added to the slurry. A suitable reducing agent, such sodium cyanoborohydride, is added to the mixture, and the reaction is allowed to proceed for a suitable time period, such as from about 8 to about 12 hours at 20° C. to 30° C. with constant overhead stirring and is washed with water and NaCl.

### VI. Method of Using

Certain disclosed aspects concern a method for separating at least one large molecule from at least one small molecule. The method may comprise: applying a sample comprising a first small molecule to be separated from a second larger molecule to a porous size exclusion support comprising at least one amine-containing moiety that can bind to or associate with the small molecule; and subjecting the container to a gravity flow, a centrifugal force, a positive pressure, a negative pressure, a vacuum or a combination thereof. The large molecule in the sample is excluded by the porous size exclusion support and is collected as a flow through.

In some aspects, the matrix is equilibrated with a suitable buffer at the pH that will be used for binding of the target small molecule. Exemplary equilibration buffers include phosphate buffers. A person of ordinary skill in the art would be familiar with these and many other suitable buffer systems.

In some aspects, the container is subjected to a centrifugal force in the range of from 0×g to 2000×g. In some exemplary aspects, the centrifugal force is 300×g, 500×g, 700×g, or 1000×g.

Samples that may be processed by methods of the disclosure may be any type of biological or clinical sample comprising biomolecules or derivatives thereof from which small molecules have to be separated or removed. Some non-limiting examples of small molecules include aprotinin, ubiquitin, cytochrome C, lactalbumin, trypsin inhibitor, carbonic anhydrase. Some non-limiting examples of large molecules include: ovalbumin, transferrin, protein A, BSA, and IgG.

FIG. 4 is a schematic depiction of an exemplary aspect of a method 500 according to the present disclosure. Method 500 comprises providing a system according to the present disclosure. The system is first spun in step 510 to remove storage solution. The matrix material is then equilibrated at step 520 using a suitable equilibration buffer. For example, the matrix material may be equilibrated multiple times, such as three times, with a suitable buffer. A sample comprising components to be separated is added to the system at step 530. The system is then subjected to spinning and sample is recovered at step 540.

Methods of the disclosure advantageously reduce the time required for processing a sample, and/or increase the quantity of small molecules removed from the sample.

### VII. Kit

The present disclosure also describes kits for implementing the methods discussed herein and/or kits that contain matrixes and/or kits that contain systems discussed herein.

Certain disclosed kits are suitable for separating a small molecule from a larger molecule. The kit may comprise: a system comprising a container comprising a porous size exclusion support comprising at least one amine-containing moiety associated with the support, wherein the pores in the porous size exclusion support trap small molecules; and a receptacle located below the container, wherein the device is operably configured for gravity flow, or can operate by applying a centrifugal force, a positive pressure, a negative pressure, a vacuum, and combinations thereof.

In some aspects, a kit of the disclosure may further comprise a device such as, but not limited to, a spin column, a multi-well filter plate, or a multi-well plate. A kit can further comprise one or more equilibration buffers packaged in one or more separate containers or included in the first container.

A kit of the disclosure may also comprise one or more reagents, such as one or more wash buffers, elution buffers, filter membranes and/or additional spin columns or multi-well plates.

Reagents and components of kits may be comprised in one or more suitable containers. A container may generally comprise at least one vial, test tube, flask, bottle, syringe, or other container, into which a component may be placed, and preferably, suitably aliquoted. Where there is more than one component in a kit they may be packaged together if suitable or the kit will generally contain a second, third or other additional container into which the additional components may be separately placed. However, in some aspects, certain combinations of components may be packaged together comprised in one container means. A kit can also include a component for containing any reagent containers in close confinement for commercial sale. Such containers may include injection or blow-molded plastic containers into which the desired vials are retained.

In some aspects, a component of a kit of the disclosure may be pre-filled with one or more of the reagents to process a sample and may be suitably aliquoted into appropriate chambers. A kit or containers thereof may have a seal to keep the internal compartments and any contents therein sterile and spill proof.

Some components of a kit are provided in one and/or more liquid solutions. Liquid solution may be non-aqueous solution, an aqueous solution, and may be a sterile solution. Components of the kit may also be provided as dried powder(s). When reagents and/or components are provided as a dry powder, the powder can be reconstituted by the addition of a suitable solvent. It is envisioned that a suitable solvent may also be provided in another container means. Kits may also comprise a container means for containing a sterile, pharmaceutically acceptable buffer and/or another diluent.

A kit of the disclosure may also include instructions for employing the kit components and may also have instructions for proper use of any other reagent not included in the kit. Instructions can include different process variations that can be implemented using the kit.

### VIII. Overview of Several Aspects

Disclosed herein are aspects of a matrix comprising a porous size exclusion support comprising crosslinked 2-hydroxyethyl cellulose and having a molecular weight cut-off greater than 30,000 Da; and at least one amine-containing moiety associated with the porous size exclusion support.

Also disclosed herein are aspects of a matrix comprising at least one amine-containing moiety; and a porous size exclusion support having a molecular weight cut-off ranging from greater than 30,000 Da to 45,000 Da and comprising 2-hydroxyethyl cellulose crosslinked with a heterocyclic compound having a structure according to Formula I,

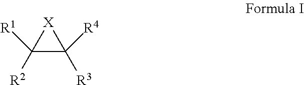

wherein: X is a heteroatom selected from nitrogen, oxygen, or sulfur; and each of R¹, R², R³, and R⁴ is independently selected from aliphatic, heteroaliphatic, haloaliphatic, halo, or glycidyl ether; wherein the at least one amine-containing moiety is associated with the porous size exclusion support.

In any or all of the above aspects, the heterocyclic compound is epichlorohydrin.

In any or all of the above aspects, the porous size exclusion support is formed by reacting an amount of 2-hydroxyethyl cellulose ranging from greater than 0 grams to 200 grams with an amount of epichlorohydrin ranging from greater than 0 milliliters to 400 milliliters.

In any or all of the above aspects, the porous size exclusion support further comprises at least one modification reagent comprising epoxybutane, epoxyhexane, epoxypropane, dimethylsulfate, episulfide, disulfide, azirine, diazirine, diglycidyl ether, or any combination thereof.

In any or all of the above aspects, the at least one amine-containing moiety is covalently bound to the porous size exclusion support.

In any or all of the above aspects, wherein, prior to association with the porous size exclusion support, the at least one amine-containing moiety is a monoamine, a diamine, or a polyamine.

In any or all of the above aspects, wherein, prior to association with the porous size exclusion support, the at least one amine-containing moiety has structure according to Formula V

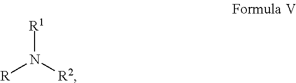

wherein: (i) at least one of R, R¹, and R² is hydrogen; (ii) at least one of R, R¹, and R² is aliphatic, heteroaliphatic, aryl, or heteroaryl; and (iii) the remaining R, R¹, or R² is hydrogen, aliphatic, heteroaliphatic, aryl, or heteroaryl.

In any or all of the above aspects, wherein at least one of R, R¹ and R² is hydrogen, and the remaining R, R¹, or R² groups independently are C₁-C₁₀ aliphatic.

In any or all of the above aspects wherein at least one of R, R¹ and R² is hydrogen, and remaining R, R¹ and R² groups are independently methyl, ethyl, propyl, isopropyl, butyl, sec-butyl, tertiary butyl, pentyl, isopentyl, hexyl, or isohexyl.

In any or all of the above aspects wherein, prior to association with the porous size exclusion support, the at least one amine-containing moiety is a diamine having a structure according to Formula VI,

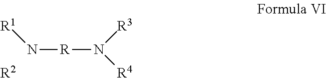

wherein: (i) R is aliphatic, heteroaliphatic, aryl, or heteroaryl, (ii) at least one of R¹, R², R³ and R⁴ is hydrogen, and (iii) the remaining R¹, R², R³ and R⁴ are independently hydrogen, aliphatic, heteroaliphatic, aryl, or heteroaryl.

In any or all of the above aspects, wherein the at least one amine-containing moiety is a diamine having a structure according to Formula VII,

H₂N—R—NH₂ Formula VII

wherein R is C₁-C₁₀ aliphatic, heteroaliphatic, aryl, or heteroaryl.

In any or all of the above aspects wherein, prior to association with the porous size exclusion support, the at least one amine-containing moiety is 1,5-diaminopentane and wherein greater than 0 mg 1,5-diaminopentane per mL of the porous size exclusion support to 10 mg 1,5-diaminopentane per mL of the porous size exclusion support is used to form the matrix.

In any or all of the above aspects, wherein, prior to association with the porous size exclusion support, the at least one amine-containing moiety is a monoamine having a structure according to Formula VIII,

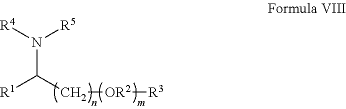

wherein: R¹ is hydrogen, aliphatic, heteroaliphatic, aryl, or heteroaryl; R² and R³ are independently aliphatic, heteroaliphatic, aryl, or heteroaryl; at least one of R⁴ and R⁵ is hydrogen, and the remaining R⁴ group or R⁵ group is hydrogen, aliphatic, heteroaliphatic, aryl, or heteroaryl; and each of m and n independently is an integer selected from 1 to 10.

In any or all of the above aspects, wherein the amine-containing moiety is O-(2-aminopropyl)-O′-(2-methoxyethyl)polypropylene glycol.

In any or all of the above aspects, the matrix is further equilibrated with a buffer.

In any or all of the above aspects, the buffer is a phosphate buffer.

In any or all of the above aspects, the porous size exclusion support having a MWCO of 40,000 Da.

Also disclosed herein are aspects for a device for separating one or more small molecules from one or more large molecules in a sample, the system comprising: a container comprising the matrix disclosed, wherein the container has a volume ranging from 0.075 mL to 50 mL.

In any or all of the above aspects container is a columnar container, a tube, a multi-well tube, a multi-well plate, or a multi-well filter plate.

In any or all of the above aspects, further comprising a receptacle located below the container to collect a first flowthrough.

In any or all of the above aspects, wherein the heterocyclic compound is epichlorohydrin; and wherein the porous size exclusion support is formed by reacting an amount of 2-hydroxyethyl cellulose ranging from greater than 0 grams to 200 grams with an amount of epichlorohydrin ranging from greater than 0 milliliters to 400 milliliters.

In any or all of the above aspects, wherein the porous size exclusion support has a MWCO of 40,000 Da; and wherein the at least one small molecule has a molecular weight less than or equal to 40,000 Da and the at least one large molecule has a molecular weight of 40,000 Da or greater.

In any or all of the above aspects wherein the small molecule is a biomolecule; a salt; an unreacted label or partially reacted label or nanoparticle, or a derivative thereof; a dye or derivative thereof; a radioactive ligand or an intermediate thereof; a mass tag; a metal; biotin or a derivative thereof; a crosslinker or derivative thereof; a reducing agent or derivative thereof; or any combination thereof.

Also disclosed herein is a kit for separating one or more large molecules from one or more small molecules in a sample, the kit comprising: a device disclosed herein, wherein the device is operably configured to operate by gravity flow, a centrifugal force, a positive pressure, a negative pressure, vacuum, or any combination thereof.

In any or all of the above aspects, the kit further comprises a buffer.

Also disclosed herein is a method for separating one or more large molecules from one or more small molecules, the method comprising: providing a sample comprising the one or more large molecules and the one or more small molecules to the matrix disclosed herein; and subjecting the matrix to a gravity flow, a centrifugal force, a positive pressure, a negative pressure, a vacuum, or any combination thereof, wherein the one or more large molecules is excluded by the matrix and is collected as a flow-through.

In any or all of the above aspects, the matrix is housed in a container.

In any or all of the above aspects, wherein the container has a volume of 0.075 mL to 50 mL.

In any or all of the above aspects, wherein the flow through is collected in a receptacle located below the container.

In any or all of the above aspects, wherein the receptable is a multi-well plate.

In any or all of the above aspects, wherein the centrifugal force is from 0×g to 1000×g.

Also disclosed herein is system for separating at least one small molecule from at least one large molecule from a sample, the system comprising a container comprising the matrix disclosed herein; and a receptacle located to receive flow from the container.

In any or all of the above aspects, the matrix is equilibrated with a buffer.

In any or all of the above aspects, the buffer is a phosphate buffer.

In any or all of the above aspects, the system is configured for gravity flow operation, centrifugal force operation, positive pressure operation, negative pressure operation, vacuum operation, or combinations thereof.

In any or all of the above aspects, the container is a columnar container, a tube, a multi-well tube, a multi-well plate, or a multi-well filter plate.

In any or all of the above aspects, the container comprises a volume ranging from 0.075 mL to 50 mL.

Also disclosed herein is a method of making a rigid size exclusion support comprising providing a porous size exclusion support comprising 2-hydroxyethyl cellulose having a MWCO greater than 30,000 Da, the 2-hydroxyethyl cellulose having at least one vicinal diol; oxidizing the least one vicinal diol to an aldehyde; and reacting the aldehyde with an amine group of an amine-containing moiety via reductive amination.

In any or all of the above aspects, prior to association with the porous size exclusion support the method comprises crosslinking the porous size exclusion support with a crosslinker.

In any or all of the above aspects, prior to the crosslinking the porous size exclusion support, the method comprises modifying the porous size exclusion support with a modifying reagent.

In any or all of the above aspects, the crosslinker is epichlorohydrin.

In any or all of the above aspects, the modification reagent is epoxybutane, epoxyhexane, epoxypropane, dimethylsulfate, episulfide, disulfide, azirine, diazirine, diglycidyl ether, or any combinations thereof.

In any or all of the above aspects, prior to association with the porous size exclusion support, the at least one amine-containing moiety has a Formula V,

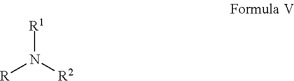

wherein: (i) at least one of R, R¹, and R² is hydrogen; (ii) at least one of R, R¹, and R² is aliphatic, heteroaliphatic, aryl, or heteroaryl; and (iii) the remaining R, R¹, or R² is hydrogen, aliphatic, heteroaliphatic, aryl, or heteroaryl; a Formula VI,

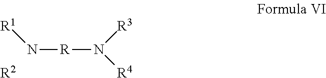

wherein: (i) R is aliphatic, heteroaliphatic, aryl, or heteroaryl, (ii) at least one of R¹, R², R³ and R⁴ is hydrogen, and (iii) the remaining R¹, R², R³ and R⁴ are independently hydrogen, aliphatic, heteroaliphatic, aryl, or heteroaryl; a Formula VII,

H₂N—R—NH₂ Formula VII,

wherein R is C₁-C₁₀ aliphatic, heteroaliphatic, aryl, or heteroaryl; or a Formula VIII,

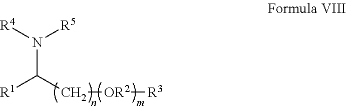

wherein R¹ is hydrogen, aliphatic, heteroaliphatic, aryl, or heteroaryl; R² and R³ are independently aliphatic, heteroaliphatic, aryl, or heteroaryl; at least one of R⁴ and R⁵ is hydrogen, and the remaining R⁴ group or R⁵ group is hydrogen, aliphatic, heteroaliphatic, aryl, or heteroaryl; and each of m and n independently is an integer selected from 1 to 10.

In any or all of the above aspects, the at least one amine-containing moiety comprises at least one oxygen.

In any or all of the above aspects, the amine-containing moiety is butylamine, 1,5-diaminopentane, or O-(2-Aminopropyl)-O′(2-methoxyethyl)polypropylene glycol.

In any or all of the above aspects, the amine-containing moiety has a concentration relative to the support material of from 0 mg of amine-containing reagent per mL of porous size exclusion support material to 55 mg of amine-containing moiety reagent per mL of porous size exclusion support material.

In any or all of the above aspects, the amine-containing aliphatic moiety is butylamine having a concentration of from greater than 0 mg of butylamine reagent per mL of porous size exclusion support material to 55 mg per mL of porous size exclusion support material; or the amine-containing moiety is 1,5-diaminopentane having a concentration of from greater than 0 mg of 1,5-diaminopentane reagent per mL of porous size exclusion support material to 10 mg of 1,5-diaminopentane reagent per mL of porous size exclusion support material; or the amine-containing moiety is O-(2-Aminopropyl)-O′-(2-methoxyethyl)polypropylene glycol having a concentration of from 0 mg of O-(2-Aminopropyl)-O′-(2-methoxyethyl)polypropylene glycol regent per mL of porous size exclusion support material to 55 mg of O-(2-Aminopropyl)-O′-(2-methoxyethyl)polypropylene glycol reagent per mL of porous size exclusion support material.

In any or all of the above aspects, the reductive amination reaction is conducted using sodium cyanoborohydride, picoline borane, or an amine borane.

Also disclosed herein is system for separating at least one small molecule from at least one large molecule from a sample, the system comprising a container comprising the matrix disclosed herein; and a receptacle located to receive flow from the container.

In any or all of the above aspects, the matrix is equilibrated with a buffer.

In any or all of the above aspects, the buffer is a phosphate buffer.

In any or all of the above aspects, the system is configured for gravity flow operation, centrifugal force operation, positive pressure operation, negative pressure operation, vacuum operation, or combinations thereof.

In any or all of the above aspects, the container is a columnar container, a tube, a multi-well tube, a multi-well plate, or a multi-well filter plate.

In any or all of the above aspects, the container comprises a volume ranging from 0.075 mL to 50 mL.

Also disclosed herein is a method of making a rigid size exclusion support comprising providing a porous size exclusion support comprising 2-hydroxyethyl cellulose having a MWCO greater than 30,000 Da, the 2-hydroxyethyl cellulose having at least one vicinal diol; oxidizing the least one vicinal diol to an aldehyde; and reacting the aldehyde with an amine group of an amine-containing moiety via reductive amination.

In any or all of the above aspects, prior to association with the porous size exclusion support the method comprises crosslinking the porous size exclusion support with a crosslinker.

In any or all of the above aspects, prior to the crosslinking the porous size exclusion support, the method comprises modifying the porous size exclusion support with a modifying reagent.

In any or all of the above aspects, the crosslinker, modifying reagent, or combination thereof comprises a heterocyclic compound having Formula I,

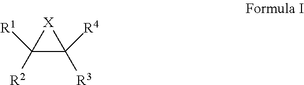

wherein: X is a heteroatom selected from nitrogen, oxygen, or sulfur; and each of R¹, R², R³, and R⁴ is independently selected from aliphatic, heteroaliphatic, haloaliphatic, halo, or glycidyl ether; wherein the at least one amine-containing moiety is associated with the porous size exclusion support.

In any or all of the above aspects, the crosslinker is epichlorohydrin.

In any or all of the above aspects, the modification reagent is epoxybutane, epoxyhexane, epoxypropane, dimethylsulfate, episulfide, disulfide, azirine, diazirine, diglycidyl ether, or any combinations thereof.

In any or all of the above aspects, prior to association with the porous size exclusion support, the at least one amine-containing moiety has a Formula V,

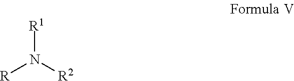

wherein: (i) at least one of R, R¹, and R² is hydrogen; (ii) at least one of R, R¹, and R² is aliphatic, heteroaliphatic, aryl, or heteroaryl; and (iii) the remaining R, R¹, or R² is hydrogen, aliphatic, heteroaliphatic, aryl, or heteroaryl; a Formula VI,

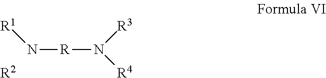

wherein: (i) R is aliphatic, heteroaliphatic, aryl, or heteroaryl, (ii) at least one of R¹, R², R³ and R⁴ is hydrogen, and (iii) the remaining R¹, R², R³ and R⁴ are independently hydrogen, aliphatic, heteroaliphatic, aryl, or heteroaryl; a Formula VII,

H₂N—R—NH₂ Formula VII,

wherein R is C₁-C₁₀ aliphatic, heteroaliphatic, aryl, or heteroaryl; or a Formula VIII,

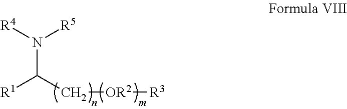

wherein R¹ is hydrogen, aliphatic, heteroaliphatic, aryl, or heteroaryl; R² and R³ are independently aliphatic, heteroaliphatic, aryl, or heteroaryl; at least one of R⁴ and R⁵ is hydrogen, and the remaining R⁴ group or R⁵ group is hydrogen, aliphatic, heteroaliphatic, aryl, or heteroaryl; and each of m and n independently is an integer selected from 1 to 10.

In any or all of the above aspects, the at least one amine-containing moiety comprises at least one oxygen.

In any or all of the above aspects, the amine-containing moiety is butylamine, 1,5-diaminopentane, or O-(2-Aminopropyl)-O′(2-methoxyethyl)polypropylene glycol.

In any or all of the above aspects, the amine-containing moiety has a concentration relative to the support material of from 0 mg of amine-containing reagent per mL of porous size exclusion support material to 55 mg of amine-containing moiety reagent per mL of porous size exclusion support material.

In any or all of the above aspects, the amine-containing aliphatic moiety is butylamine having a concentration of from greater than 0 mg of butylamine reagent per mL of porous size exclusion support material to 55 mg per mL of porous size exclusion support material; or the amine-containing moiety is 1,5-diaminopentane having a concentration of from greater than 0 mg of 1,5-diaminopentane reagent per mL of porous size exclusion support material to 10 mg of 1,5-diaminopentane reagent per mL of porous size exclusion support material; or the amine-containing moiety is O-(2-Aminopropyl)-O′-(2-methoxyethyl)polypropylene glycol having a concentration of from 0 mg of O-(2-Aminopropyl)-O′-(2-methoxyethyl)polypropylene glycol regent per mL of porous size exclusion support material to 55 mg of O-(2-Aminopropyl)-O′-(2-methoxyethyl)polypropylene glycol reagent per mL of porous size exclusion support material.

In any or all of the above aspects, the reductive amination reaction is conducted using sodium cyanoborohydride, picoline borane, or an amine borane.

### IX. Examples

Aspects of the present teachings can be further understood in light of the following examples.

Resin A: a comparative example, also referred to herein as “Resin A”, or “comparative resin”, or “comparator” was produced by crosslinking 2-hydroxyethyl cellulose with epichlorohydrin. More specifically, Resin A (1.5 L resin bed) was prepared by mixing approximately 173 g of 2-hyrdoxyethyl cellulose with 170 mL of 50 weight percent sodium hydroxide and 2.2 g of sodium borohydride in approximately 840 mL of water. The mixture was then moderately stirred overnight with an overhead stirrer at ambient temperature. On the following day, the mixture was heated to approximately 70° C. and mixed with 42 g of Rhodafac-PE-510 and dissolved in approximately 840 mL of cyclohexane. This reaction slurry was then stirred at high RPM and heated at 70° C. for 2-3 hours to form a stable emulsion, which is crosslinked with 190 mL (224.8 g) of epichlorohydrin maintaining the temperature at 70° C. with continued heating and stirring for an additional 3 hours at high RPM. After 3 hours, an additional 50 weight percent sodium hydroxide (140 mL), water (75 mL), and sodium borohydride (0.75 g) were added for final crosslinking with an additional 75 mL (88.7 g) of epichlorohydrin. After heating and stirring for approximately 0.5-hour, heat was removed, and the mixture was stirred at high RPM overnight allowing for the reaction slurry to cool to ambient temperature. On the following day, the resin obtained was rinsed with water and classified with 37 μm to 250 μm sieves to get the desired average particle size.

Resin B: Resin A was modified to form Resin B by decreasing the amount of HEC used in Resin A. Resin B which was prepared by mixing approximately 129 g of HEC crosslinked with 265 mL (313.5 g) of epichlorohydrin following the same protocol as described for Resin A. Thus, approximately 129 g of 2-hydroxyethyl cellulose is mixed with 170 mL of 50 weight percent sodium hydroxide & 2.2 g of sodium borohydride in approximately 860 mL of water. The mixture was then moderately stirred overnight with an overhead stirrer at ambient temperature. On the following day, the mixture was heated to approximately 70° C. and mixed with 38 g of Rhodafac-PE-510 and dissolved in approximately 840 mL of cyclohexane. This reaction slurry was then stirred at high RPM and heated at 70° C. for 2-3 hours to form a stable emulsion, which is crosslinked with 190 mL (224.8 g) of epichlorohydrin maintaining the temperature at 70° C. with continued heating and stirring for an additional 3 hours at high RPM. After 3 hours, an additional 50 weight percent sodium hydroxide (140 mL), water (75 mL), and sodium borohydride (0.75 g) were added for final crosslinking with an additional 75 mL (88.7 g) of epichlorohydrin. After heating and stirring for approximately 0.5 hour, the heat was removed, and the mixture was stirred at high RPM overnight allowing for the reaction slurry to cool to ambient temperature. On the following day, the resin obtained was rinsed with water and classified with 37 μm to 250 μm sieves to get the desired average particle size.

Resin C: Resin A was modified to form Resin C by decreasing the amount of HEC and increasing the amount of Epi. Resin C was prepared by mixing approximately 129 g of HEC crosslinked with 397.5 mL (470.2 g) of epichlorohydrin following the same protocol as described for Resin A. Thus, approximately 129 g of 2-hydroxyethyl cellulose is mixed with 170 mL of 50 weight percent sodium hydroxide & 2.2 g of sodium borohydride in approximately 860 mL of water. The mixture was then moderately stirred overnight with an overhead stirrer at ambient temperature. On the following day, the mixture was heated to approximately 70° C. and mixed with 38 g of Rhodafac-PE-510 and dissolved in approximately 840 mL of cyclohexane. This reaction slurry was then stirred at high RPM and heated at 70° C. for 2-3 hours to form a stable emulsion, which is crosslinked with 285 mL (337.1 g) of epichlorohydrin maintaining the temperature at 70° C. with continued heating and stirring for an additional 3 hours at high RPM. After 3 hours, an additional 50 weight percent sodium hydroxide (140 mL), water (75 mL), and sodium borohydride (0.75 g) was added for final crosslinking with an additional 112.5 mL (133.1 g) of epichlorohydrin. After heating and stirring for approximately 0.5 hour, the heat was removed, and the mixture was stirred at high RPM overnight allowing for the reaction slurry to cool to ambient temperature. On the following day, the resin obtained was rinsed with water and classified with 37 μm to 250 μm sieves to get the desired average particle size.

Resin D: Post modification chemistry was applied to Resin C to form Resin D. Specifically, sieved Resin C was post modified by using sodium metaperiodate (23 mg/ml of resin bed), 0-(2-Aminopropyl)-O′-(2-methoxyethyl)polypropylene glycol (2.5 mg/mL of resin), & picoline borane (2.5 mg/mL of resin) at room temperature and stirred overnight. On the following day, the resin was filtered & rinsed with water to afford the modified resin, Resin D.

Resin E: Post modification chemistry was applied to Resin C to form Resin E. Specifically, sieved Resin C was post modified by using sodium metaperiodate (23 mg/ml of resin bed), 1,5-diaminopentane (5 mg/mL of resin), & picoline borane (5 mg/mL of resin) at room temperature and stirred overnight. On the following day, the resin was filtered & rinsed with water to afford the modified resin, Resin E.

Table 1 summarizes modifications of Resins A-E.

TABLE 1

| | Amount | | | |
|---|---|---|---|---|
| | of HEC | Amount of Epi | | |
| | (Grams) | (Milliliters) | | Post Modification Chemistry |
| Resin A | 173 | 265 | (313.5 g) | None |
| Resin B | 129 | 265 | (313.5 g) | None |
| Resin C | 129 | 397.5 | (470.2 g) | None |
| Resin D | 129 | 397.5 | (470.2 g) | O-(2-Aminopropyl)-O′-(2- |
| | | | | methoxyethyl)polypropylene glycol |
| Resin E | 129 | 397.5 | (470.2 g) | 1,5-Diaminopentane |

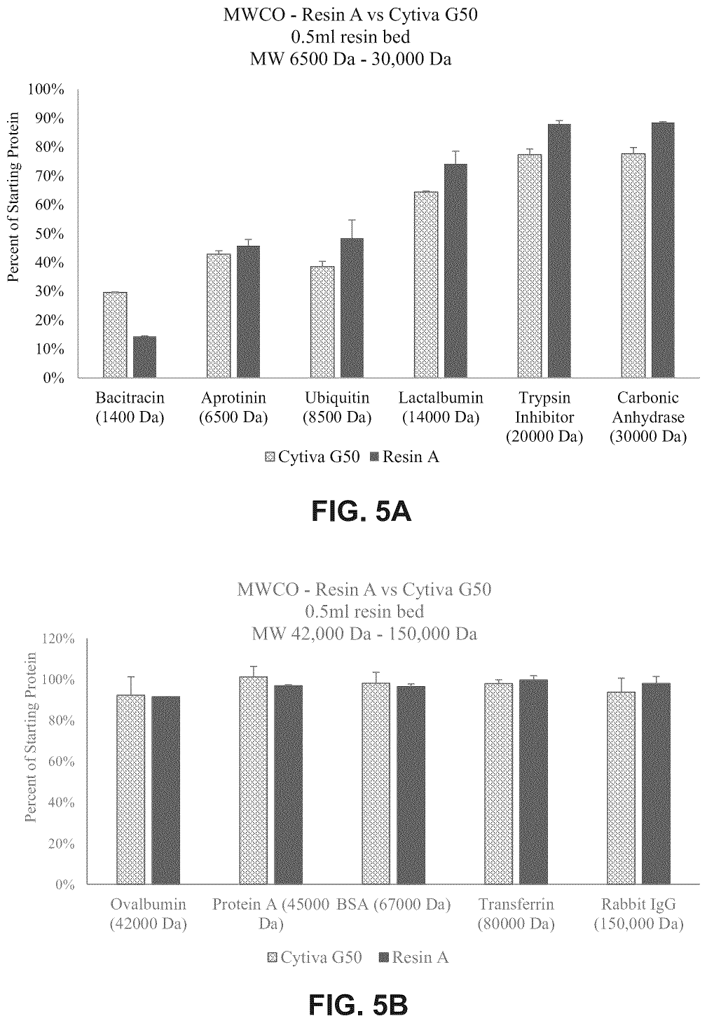

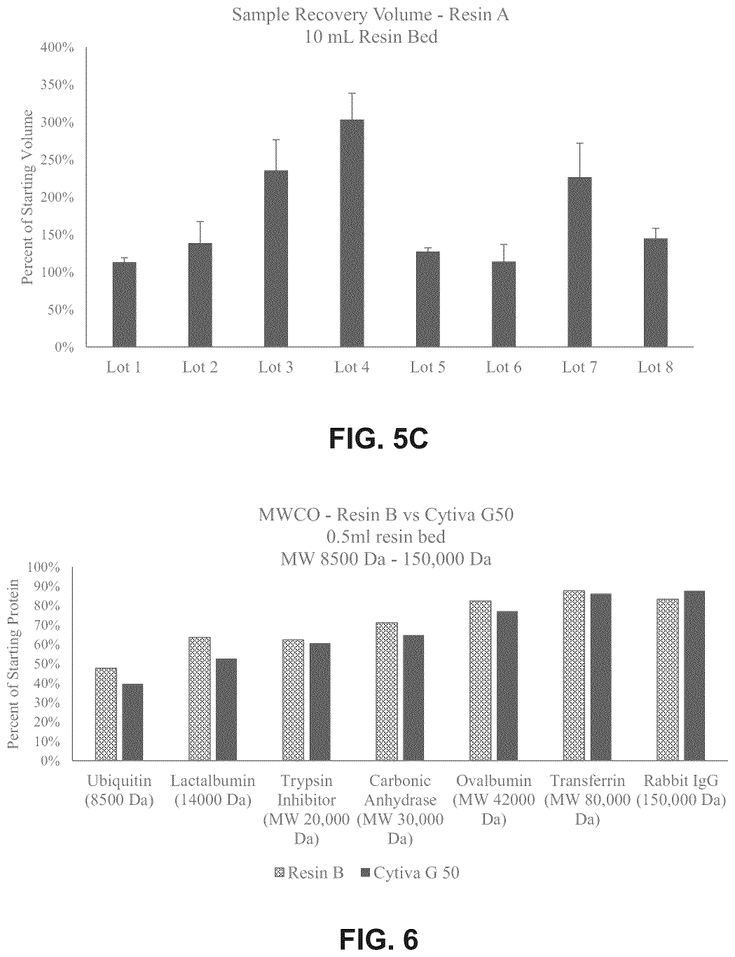

MWCO Determination: The MWCO (see FIGS. 5A-5B, 6, 10A-10B) was determined by providing 562 μL of the resin bed. Next, the resins were equilibrated thrice with 300 μL of PBS and spun at 700×G. Then, 100 μL of 0.5 mg/mL proteins having different molecular weights were added to the resin, the columns were spin at 700×G, and the flowthrough comprising the unbound protein was collected in a 2 mL centrifuge tube (see FIG. 4). The amount of flowthrough was calculated using BCA protein assay and the percent recoveries of the different proteins was calculated.

Procedure for Determining Protein and Volume Recovery (10 mL column): Protein and volume recovery was determined by providing 10 ml of resin bed into a spin column and centrifuged at 700×G for 2 minutes thereby removing the storage solution. Next, the column was equilibrated by adding 1 mL of buffer to the resin bed and spun at 700×G for two minutes. A second equilibration was performed, which was centrifuged for 3 minutes and followed by a third equilibration for five minutes. The sample comprising BSA (1 mL of 0.5 mg/mL) was added to the equilibrated column and centrifuged for 4 minutes (see FIG. 4). The volume recovery was determined by weighing the tube before and after the sample was eluted and taking the difference. Protein recovery was determined by multiplying the concentration (based on BCA Protein Assay) by the recovered volume.

### Example 1

In this example, Resin A was compared to Cytiva G 50, which was used as a positive control to determine the recovery of different sized proteins having different molecular weights. The data of this example was obtained by using a 0.5 mL resin bed for Resin A and Cytiva G 50. Proteins were made at 0.5 mg/mL concentration and were added at 100 μL volume to the resin bed and the recoveries of the proteins were determined using BCA protein assay.

FIG. 5A provides the lower molecular weight protein recovery data for Resin A versus Cytiva G 50. In view of FIG. 5A, Resin A had a 46% recovery of Aprotinin (6,500 Da); 48% recovery of Ubiquitin (8,500 Da); 74% recovery of Lactalbumin (14,000 Da), 88% recovery of Trypsin Inhibitor (20,000 Da); and 89% of Carbonic Anhydrase (30,000 Da). Cytiva G 50 had a 43% of Aprotinin (6,500 Da); a 39% recovery of Ubiquitin (8,500 Da); 64% recovery of Lactalbumin (14,000 Da); 77% recovery of Trypsin Inhibitor (20,000 Da); and an 89% recovery of Carbonic Anhydrase (30,000 Da).

Moreover, FIG. 5B provides the higher molecular weight protein recovery data for Resin A versus Cytiva G 50. Resin A had a 91% recovery of Ovalbumin (42,000 Da); 97% recovery of Protein A (45,000 Da); 96% recovery of BSA (67,000 Da); 100% recovery of Transferrin (80,000 Da); and 98% recovery of Rabbit IgG (150,000 Da). Cytiva G 50 had a 92% recovery of Ovalbumin (42,000 Da); 101% recovery of Protein A (45,000 Da); 98% recovery of BSA (67,000 Da); 98% recovery of Transferrin (80,000 Da); and 98% recovery of Rabbit IgG (150,000 Da).

Thus, Resin A had a significantly higher protein recovery for proteins having a lower molecular weight, such as from 6,500 Da to 30,000 Da, which is below the 40,000 Da MWCO; unlike Cytiva G 50, which had a lower protein recovery for proteins having a lower molecular weight, such as from 6,500 Da to 30,000 Da. Therefore, this example demonstrates Cytiva G 50 exhibited a 40,000 Da MWCO unlike Resin A.

### Example 2

In this example, samples of Resin A were tested from different lots to determine the consistency of sample volume recoveries. In some aspects of the disclosure, it can be beneficial to have a volume recovery percentage closer to 100%. The data of this example was obtained by using a 10 mL resin bed for different lots of Resin A. BSA protein was added at 1 mL volume to the resin bed and the volume recovery was determined by weighing the tube before and after the sample was eluted and taking the difference. FIG. 5C provides the sample volume recovery data of Resin A, which was selected from eight different lots. Accordingly, Lot 1 had a 113% sample recovery volume, Lot 2 had a 139% sample recovery volume; Lot 3 had a 236% sample recovery volume; Lot 4 had a 303% sample recovery volume; Lot 5 has a 128% sample recovery volume; Lot 6 had a 114% sample recovery volume; Lot 7 had a 227% sample recovery volume; and Lot 8 had a 145% sample recovery volume. Thus, this example illustrates inconsistent sample volume recoveries by Resin A.

### Example 3

The data of this example was obtained by using a 0.5 mL resin bed of Resin B as specified in Table 1 and Cytiva G 50. Proteins were made at 0.5 mg/mL concentration and were added at 100 μL volume to the resin bed. BCA protein assay was used to determine the protein recoveries.

FIG. 6 shows the protein recovery data of proteins having different molecular weights for 0.5 mL resin bed of the Resin B example versus Cytiva G 50. The Resin B example had a 48% recovery of Ubiquitin (8,500 Da); 64% recovery of Lactalbumin (14,000 Da); 62% recovery of Trypsin Inhibitor (20,000 Da); 71% recovery of Carbonic Anhydrase (30,000 Da); 82% recovery of Ovalbumin (42,000 Da); 88% recovery of Transferrin (80,000 Da); and 83% recovery of Rabbit IgG (150,000 Da). Cytiva G 50 had a 40% recovery of Ubiquitin (8,500 Da); 53% recovery of Lactalbumin (14,000 Da); 61% recovery of Trypsin Inhibitor (20,000 Da); 65% recovery of Carbonic Anhydrase (30,000 Da); 77% recovery of Ovalbumin (42,000 Da); 86% recovery of Transferrin (80,000 Da); and 88% recovery of Rabbit IgG (150,000 Da).

In view of FIG. 6, the Resin B example had similar protein recoveries percentages to that of Cytiva G 50, specifically proteins having a lower molecular weight (listed left of the arrow in FIG. 6). Therefore, this example demonstrates that the Resin B example, which used 25% less HEC than Resin A, exhibited results closer to 40,000 Da MWCO.

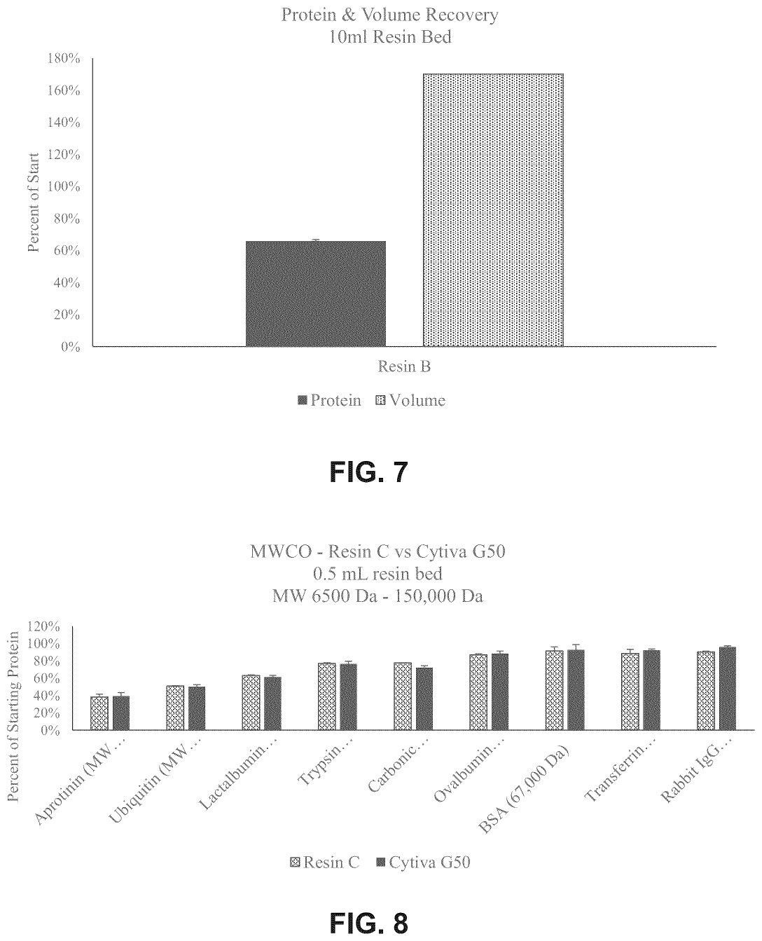

FIG. 7 shows the protein and volume recovery data of the Resin B example on a 10 mL resin bed. Accordingly, the Resin B example had a 66% protein recovery and 170% volume recovery. In some examples, a desirable volume recovery percentage range is from 80% to 120%, thus the undesirable 170% volume recovery of the Resin B example demonstrates no improvement in the flowthrough properties in larger sized columns, similar to Resin A.

### Example 4

This example concerns Resin C, which was formed by using 25% less HEC, crosslinked with 50% more Epi than Resin A (as described in Table 1). The data of this example was obtained by using a 0.5 mL resin bed for Resin C and Cytiva G 50. Proteins were made at 0.5 mg/mL concentration and were added at 100 μL volume to the resin bed and the recoveries of the proteins were determined using BCA protein assay.

FIG. 8 depicts the protein recovery data of the Resin C example versus Cytiva G 50 for proteins having different molecular weights, wherein the proteins left of the arrow in FIG. 8 demonstrate the proteins having a lower molecular weight. Accordingly, the Resin C example had a 38% recovery of Aprotinin (6,500 Da); 51% recovery of Ubiquitin (8,500 Da); 63% recovery of Lactalbumin (14,000 Da), 77% recovery of Trypsin Inhibitor (20,000 Da); and 78% recovery of Carbonic Anhydrase (30,000 Da); 87% recovery of Ovalbumin (42,000 Da); 91% recovery of BSA (67,000 Da); 89% recovery of Transferrin (80,000 Da); and 90% recovery of Rabbit IgG (150,000 Da). Whereas Cytiva G 50 had a 39% recovery of Aprotinin (6,500 Da); 50% recovery of Ubiquitin (8,500 Da); 61% recovery of Lactalbumin (14,000 Da), 76% recovery of Trypsin Inhibitor (20,000 Da); 72% recovery of Carbonic Anhydrase (30,000 Da); 88% recovery of Ovalbumin (42,000 Da); 93% recovery of BSA (67,000 Da); 92% recovery of Transferrin (80,000 Da); and 96% recovery of Rabbit IgG (150,000 Da). Therefore, this example indicates that by reducing the amount of HEC by 25% than Resin A and increasing the crosslinker (Epi) by 50% more than Resin A, the Resin C example demonstrated a 40,000 Da MWCO, as evidenced by the percentage of proteins having a lower molecular weight (left of the arrow in FIG. 8), similar to Cytiva G 50.

### Example 5

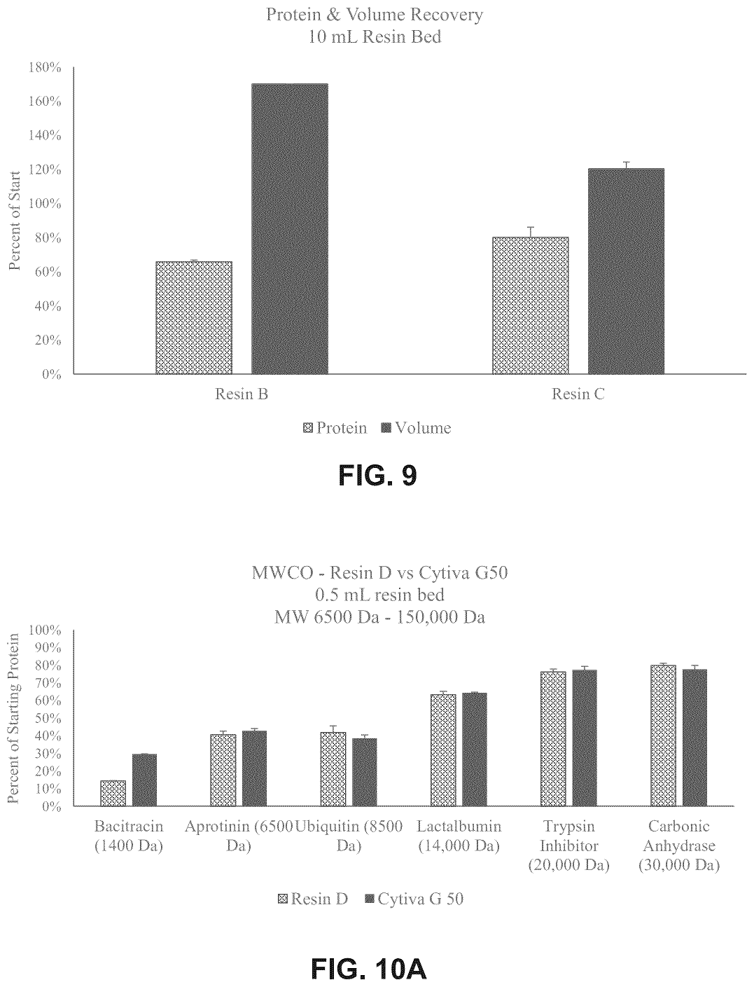

In the example, the protein and volume recovery of Resin B as specified in Table 1 and Resin C as specified in Table 1 in 10 mL resin bed columns were compared. FIG. 9 shows the protein and volume recovery data of the Resin B example and the Resin C example in 10 mL columns. The Resin B example had a 66% protein recovery and a volume recovery of approximately 170%. The Resin C example had an 80% protein recovery and a volume recovery of 120%. Thus, this example demonstrates that by increasing the amount of Epi by 50% in forming the Resin C example, the flowthrough property (volume recovery) of the Resin C example improved in larger sized 10 mL columns.

### Example 6

In this example, Resin C (as described in Table 1) was post modified to improve performance consistency with respect to the volume recovery. In view of this, Resin C was reacted (i.e., post modified) with O-(2-Aminopropyl)-O′-(2-methoxyethyl)polypropylene glycol (MJ), which has both hydrophobic and hydrophilic properties, to form the Resin D example (as described in Table 1). The protein recovery data (0.5 mL resin bed) of the Resin D example was compared to the protein recovery data of Cytiva G 50. Proteins were made at a 0.5 mg/mL concentration, added at 100 μL volume to the resin bed, and the recoveries of the proteins were determined using BCA protein assay.

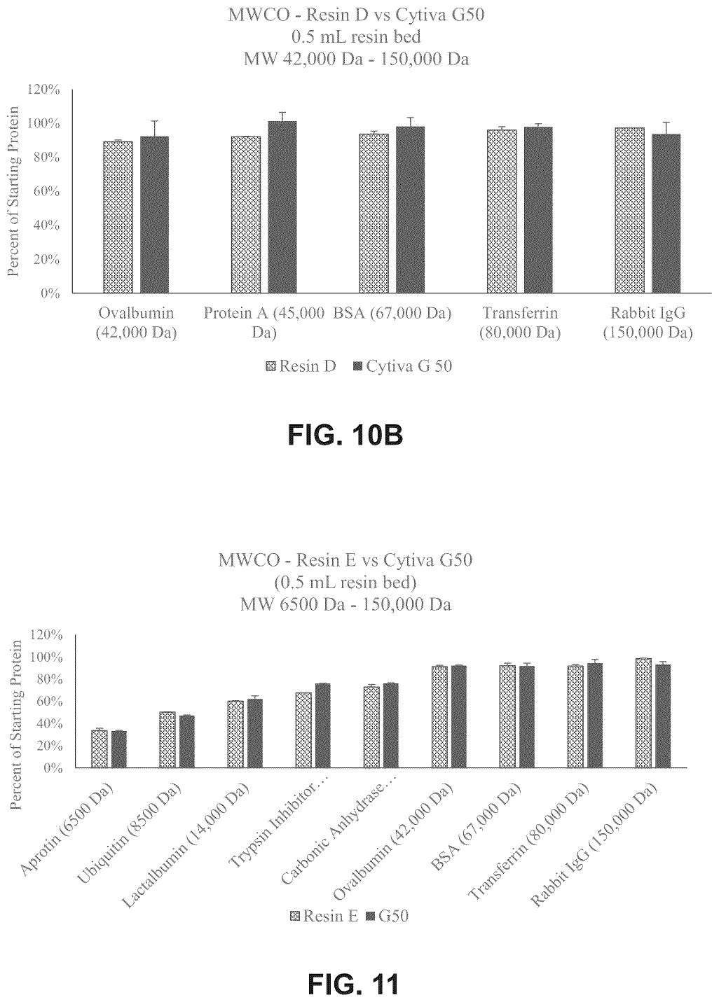

FIGS. 10A-10B provides the protein recovery data (0.5 mL resin bed) comparing the Resin D example versus Cytiva G 50. FIG. 10A depicts the protein recovery data for proteins having lower molecular weights ranging from 6,500 Da to 30,000 Da. The Resin D example had a 41% recovery of Aprotinin (6,500 Da); 42% recovery of Ubiquitin (8,500 Da); 63% recovery of Lactalbumin (14,000 Da), 76% recovery of Trypsin Inhibitor (20,000 Da); and 80% recovery of Carbonic Anhydrase (30,000 Da). Whereas Cytiva G 50 had a 43% recovery of Aprotinin (6,500 Da); 39% recovery of Ubiquitin (8,500 Da); 64% recovery of Lactalbumin (14,000 Da), 77% recovery of Trypsin Inhibitor (20,000 Da); and 78% recovery of Carbonic Anhydrase (30,000 Da). FIG. 10B depicts the protein recovery data for proteins having a higher molecular weight ranging from 42,000 Da to 150,000 Da. Accordingly, the Resin D example had an 89% recovery of Ovalbumin (42,000 Da); 92% recovery of Protein A (45,000 Da); 94% recovery of BSA (67,000 Da); 96% recovery of Transferrin (80,000 Da); and 97% recovery of Rabbit IgG (150,000 Da). Whereas Cytiva G 50 had a 92% recovery of Ovalbumin (42,000 Da); 101% recovery of Protein A (45,000 Da); 98% recovery of BSA (67,000 Da); 98% recovery of Transferrin (80,000 Da); and 94% recovery of Rabbit IgG (150,000 Da).

This example demonstrates that the Resin D as specified in Table and Cytiva G 50 had similar recoveries at lower MWCO's such as from 6,500 Da to 30,000 Da, and thus, the Resin D example demonstrated a 40,000 Da MWCO.

### Example 7

In this example, the Resin C example (as described in Table 1) was post modified with PDA to form Resin E (as described in Table 1). The data of this example was obtained by using a 0.5 mL resin bed for Resin E as specified in Table 1 and Cytiva G 50. Proteins were made at 0.5 mg/mL concentration and were added at 100 μL volume to the resin bed and the recoveries of the proteins were determined using BCA protein assay.

FIG. 11 provides the protein recovery data comparing the Resin E example versus Cytiva G 50. In view of FIG. 11, the Resin E example had a 33% recovery of Aprotinin (6,500 Da); 50% recovery of Ubiquitin (8,500 Da); 60% recovery of Lactalbumin (14,000 Da), 67% recovery of Trypsin Inhibitor (20,000 Da); 73% recovery of Carbonic Anhydrase (30,000 Da); 91% recovery of Ovalbumin (42,000 Da); 92% recovery of BSA (67,000 Da); 92% recovery of Transferrin (80,000 Da); and 98% recovery of Rabbit IgG (150,000 Da). Whereas Cytiva G 50 had a 33% recovery of Aprotinin (6,500 Da); 47% recovery of Ubiquitin (8,500 Da); 62% recovery of Lactalbumin (14,000 Da), 76% recovery of Trypsin Inhibitor (20,000 Da); 76% recovery of Carbonic Anhydrase (30,000 Da); 92% recovery of Ovalbumin (42,000 Da); 92% recovery of BSA (67,000 Da); 94% recovery of Transferrin (80,000 Da); and 93% recovery of Rabbit IgG (150,000 Da).

In view of the results shown in FIG. 11, at lower MWCO's, such as from 6,500 Da to 30,000 Da to the left of the arrow, the Resin E example and Cytiva G 50 had similar recoveries to the right of the arrow, and thus, the Resin E example demonstrated a 40,000 Da MWCO.

### Example 8

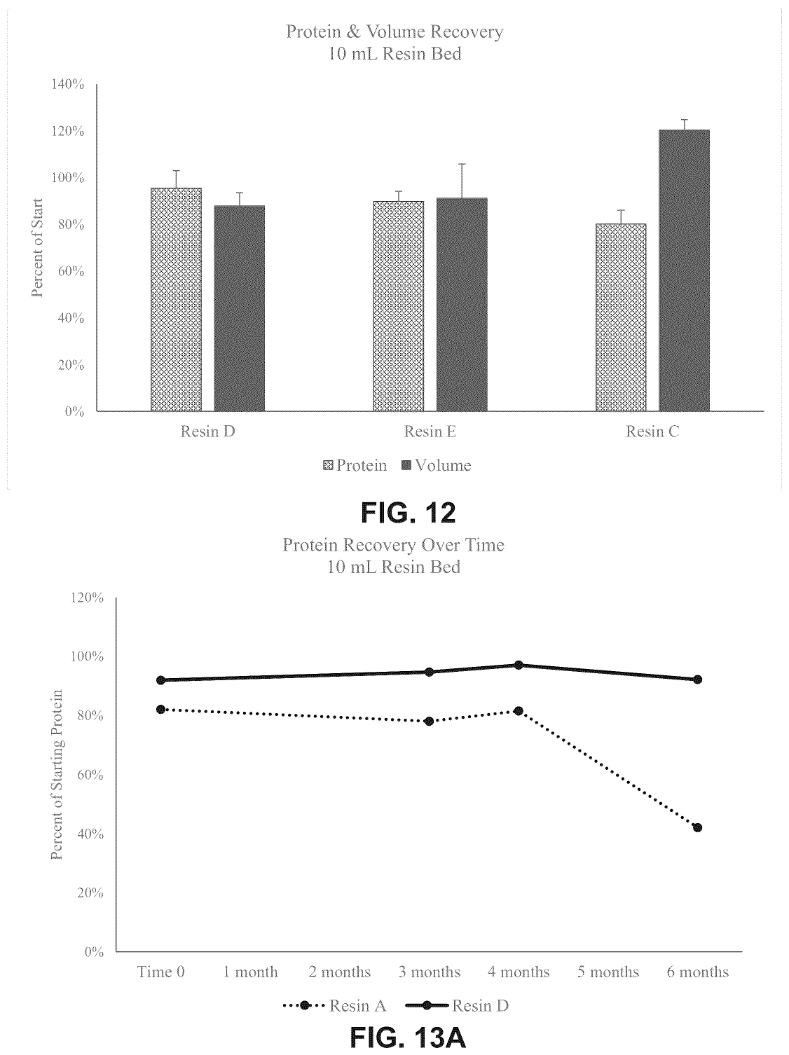

In this example, the protein recovery and volume recovery of Resin D as specified in Table 1 and Resin E as specified in Table 1 were compared to the protein recovery and volume recovery of Resin C as specified in Table 1. FIG. 12 shows the 10 mL column protein recovery and volume recovery data for the Resin D example, Resin E example, and Resin C example. The Resin D example had a 95% of start protein recovery and an 88% of start volume recovery. The Resin E example had an 90% of start protein recovery and a 91% of start volume recovery. The Resin C example had an 80% of start protein and a 120% of start volume recovery.

This example illustrates an increase in protein recovery and a decrease in volume recovery of the Resin D example and the Resin E example in comparison to their parent, the Resin C example. Therefore, the Resin D example and the Resin E example maintained a 40,000 Da MWCO and desirable flowthrough properties (volume recovery).

### Example 9

In this example, the stability of Resin A was compared to stability of Resin D as specified in Table 1 by measuring the protein recovery and volume recovery over time in 10 mL columns.

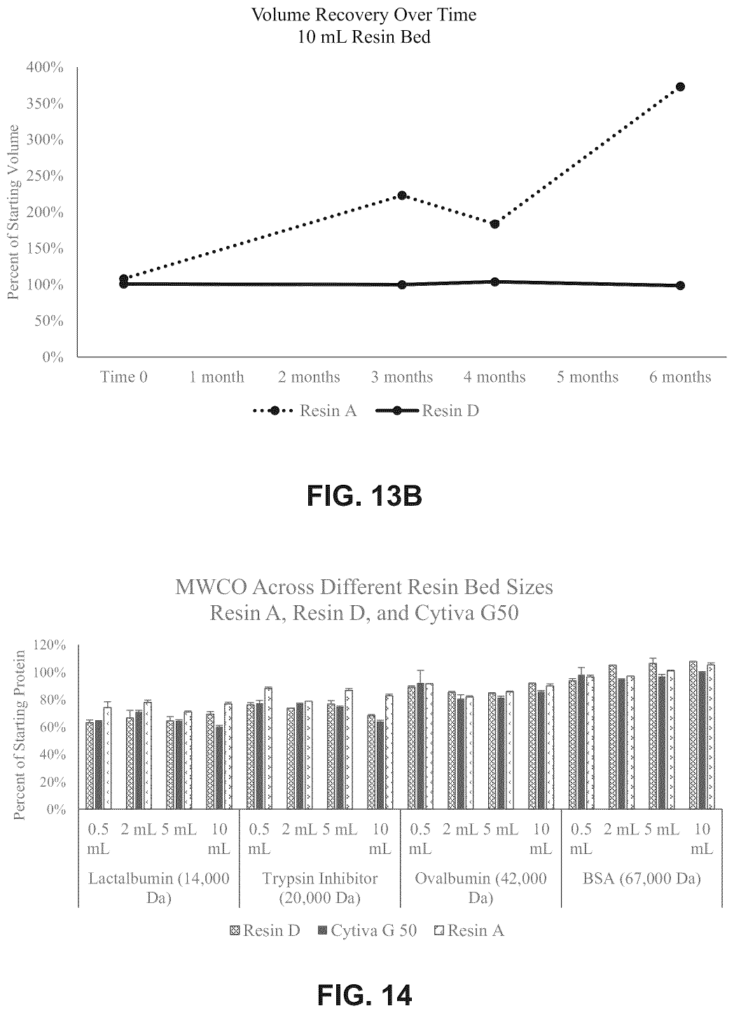

FIG. 13A depicts the protein recovery data over time of the Resin A example versus the Resin D example, where Resin A had an 82% of protein recovery at time 0; 78% of protein recovery at 3 months; an 82% protein recovery at 4 months; and a 42% protein recovery at 6 months. Resin D had an 92% of t protein recovery at time 0; a 95% protein recovery at 3 months; an 97% protein recovery at 4 months; and a 92% start protein recovery at 6 months. Accordingly, these results demonstrate an improvement in the Resin D example versus Resin A.

FIG. 13B depicts the volume recovery data of Resin A versus the Resin D example, where the Resin A example had a 108% volume recovery at time 0; a 223% start volume recovery at 3 months; a 184% start volume recovery at 4 months; and a 373% start volume recovery at 6 months. On the other hand, the Resin D example had a 99% to volume recovery at time 0, 3 months, 4 months, and at 6 months.

Therefore, this example demonstrates the improved performance stability of Resin D as specified in Table 1 versus Resin A, illustrated by the consistent dewatering (volume recovery) and protein recovery over time by the Resin D example.

### Example 10

In this example, the MWCO of Resin A, Resin D as specified in Table 1, and Cytiva G 50 were compared in a 0.5 mL spin column, 2 mL spin column, 5 mL spin column, and a 10 mL spin column. The MWCO was determined by the percent recovery of Lactalbumin (14,000 Da), Trypsin Inhibitor (20,000 Da), Ovalbumin (42,000 Da), and BSA (67,000 Da). Resins were equilibrated with PBS and proteins were added at a concentration of 0.5 mg/mL to accordingly to each the 0.5 mL, 2 mL, 5 mL, and 10 mL spin columns. The protein recovery was determined by BCA protein assay.

FIG. 14 shows the protein recovery data of the small proteins with a molecular weight less than 40,000 Da and larger proteins with a molecular weight greater than 40,000 Da on four different sized resin bed spin columns.

The Resin D example had a 63% recovery of Lactalbumin in the 0.5 mL spin column; 66% recovery of Lactalbumin in the 2 mL spin column; a 64% recovery of Lactalbumin in the 5 mL spin column; and a 69% recovery of Lactalbumin. Moreover, the Resin D example had a 76% recovery of Trypsin Inhibitor in the 0.5 mL spin column; a 74% recovery of Trypsin inhibitor in the 2 mL column; a 77% recovery of Trypsin inhibitor in the 5 mL spin column; and a 68% recovery of Trypsin Inhibitor in the 10 mL spin column. For larger proteins, the Resin D example had an 89% recovery of Ovalbumin in the 0.5 mL spin column; an 85% recovery of Ovalbumin in the 2 mL spin column; an 84% recovery of Ovalbumin in the 5 mL spin column; and a 92% recovery of Ovalbumin in the 10 mL spin column. Furthermore, the Resin D example had a 94% recovery of BSA in the 0.5 mL spin column; 105% recovery of BSA in the 2 mL column; 106% recovery of BSA in the 5 mL spin column; and a 108% recovery of BSA in the 10 mL spin column.

Cytiva G 50 had a 64% recovery of Lactalbumin in the 0.5 mL spin column; 71% recovery of Lactalbumin in the 2 mL spin column; a 64% recovery of Lactalbumin in the 5 mL spin column; and a 60% recovery of Lactalbumin. Moreover, Cytiva G 50 had a 77% recovery of Trypsin Inhibitor in the 0.5 mL spin column; a 77% recovery of Trypsin inhibitor in the 2 mL column; a 75% recovery of Trypsin inhibitor in the 5 mL spin column; and a 64% recovery of Trypsin Inhibitor in the 10 mL spin column. For larger sized proteins, Cytiva G 50 had a 92% recovery of Ovalbumin in the 0.5 mL spin column; an 81% recovery of Ovalbumin in the 2 mL spin column; an 81% recovery of Ovalbumin in the 5 mL spin column; and an 86% recovery of Ovalbumin in the 10 mL spin column. Moreover, Cytiva G 50 had a 98% recovery of BSA in the 0.5 mL spin column; 95% recovery of BSA in the 2 mL column; 97% recovery of BSA in the 5 mL spin column; and a 100% recovery of BSA in the 10 mL spin column.

Resin A had a 74% recovery of Lactalbumin in the 0.5 mL spin column; 78% recovery of Lactalbumin in the 2 mL spin column; a 71% recovery of Lactalbumin in the 5 mL spin column; and a 77% recovery of Lactalbumin. Moreover, Resin A had an 88% recovery of Trypsin Inhibitor in the 0.5 mL spin column; a 79% recovery of Trypsin inhibitor in the 2 mL column; an 87% recovery of Trypsin inhibitor in the 5 mL spin column; and an 83% recovery of Trypsin Inhibitor in the 10 mL spin column. For the larger proteins, Resin A had a 91% recovery of Ovalbumin in the 0.5 mL spin column; an 82% recovery of Ovalbumin in the 2 mL spin column; an 86% recovery of Ovalbumin in the 5 mL spin column; and an 90% recovery of Ovalbumin in the 10 mL spin column. Moreover, Resin A had a 96% recovery of BSA in the 0.5 mL spin column; 97% recovery of BSA in the 2 mL column; 101% recovery of BSA in the 5 mL spin column; and a 105% recovery of BSA in the 10 mL spin column.

This example demonstrates that Cytiva G 50 and the Resin D example had a lower protein recovery for smaller proteins having a molecular weight less than 40,000 Da; therefore, the Resin D example and Cytiva G 50 demonstrated a 40,000 Da MWCO across different sized spin columns.

### Example 11

In this example, the ability of the Resin C as specified in Table 1 and Resin D as specified in Table 1 to collect low concentrations and quantities of proteins were compared to Cytiva G 50 and Bio Rad P 30. Additionally, the volume recovery (10 mL spin columns) and rabbit IgG recovery percentage (100 μg load on 10 mL spin column) of Resin C as specified in Table 1 and Resin D as specified in Table 1 were compared.

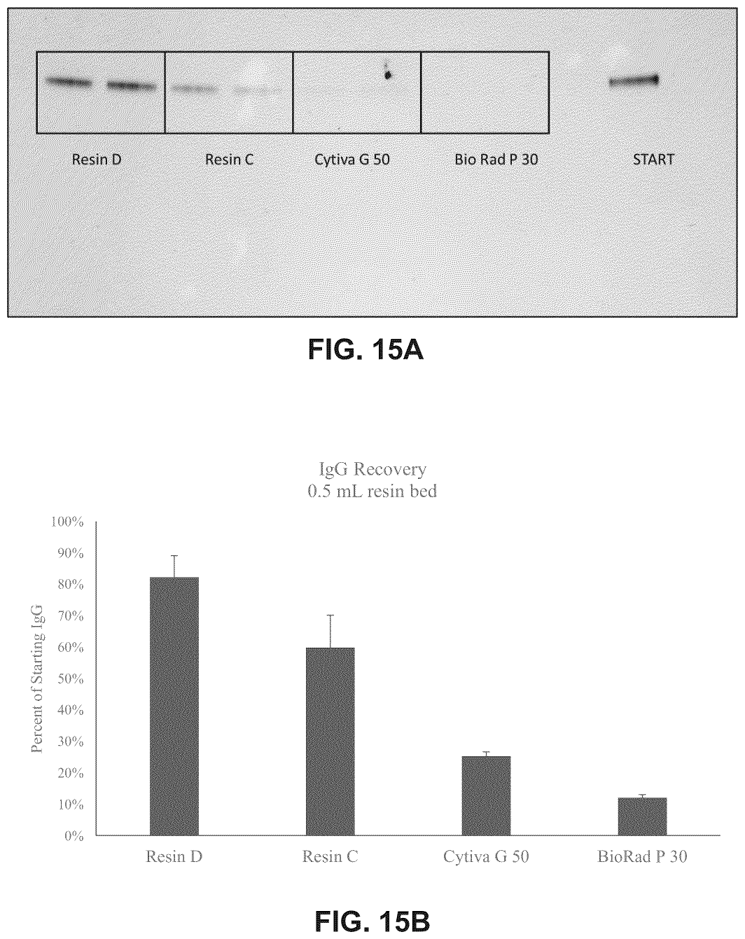

A silver-stained gel of 250 nanograms (ng) IgG was loaded on the Resin C example, Resin D example, Cytiva G60, and Bio-Rad P-30. FIG. 15A is an image of the silver-stained recovery gel of 250 ng IgG loaded on the Resin C example, the Resin D example, Cytiva G60, and Bio-Rad P-30, wherein the band corresponds to the recovered IgG. FIG. 15B is a bar graph (average of duplicate of lanes) showing band quantification from the silver-stained gel of FIG. 15A using Bright Image Analysis software indicating the IgG percentage recovery.

As can be seen from FIG. 15A, the Resin D example and the Resin C example displayed thicker bands on the silver-stained gel than Cytiva G 50 and Bio-Rad P-30, and thus the Resin D example and the Resin C example had superior low protein recovery, which is further confirmed by the results in FIG. 15B. Moreover, as shown by FIG. 15A, the Resin D example demonstrated thicker bands than the Resin C example, which demonstrates at least one advantage of utilizing the post modification chemistry with MJ because of the higher protein recovery at low protein loads exhibited by the Resin D example.

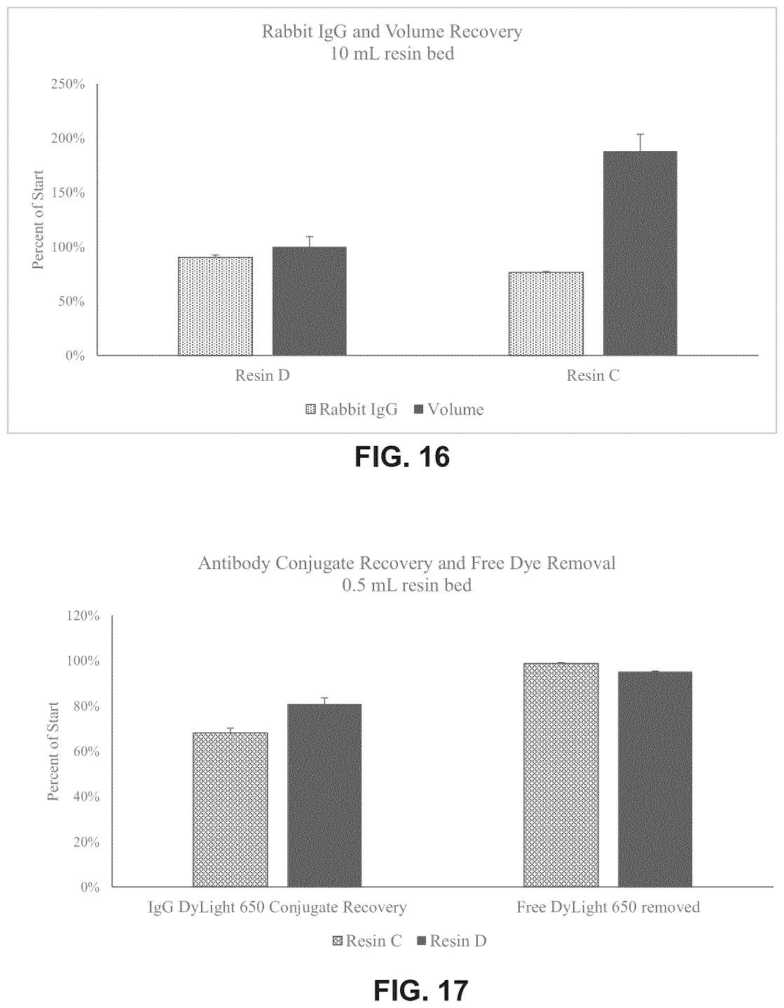

Next, the volume recovery (10 mL spin columns) and rabbit IgG recovery percentage (100 μg load on 10 mL spin column) of the Resin C example and the Resin D example were compared. FIG. 16 is a bar graph showing the recovery percentage of rabbit IgG recovery for 100 μg load onto 10 mL of resin bed and the volume recovery percentage for 1 mL of 0.1 mg/mL Rabbit IgG added to 10 mL of resin bed for the Resin C example and the Resin D example.

As shown by FIG. 16, there was a significant difference in volume and protein recovery when tested in 10 mL spin columns. The Resin C example had a volume recovery of 188%, and hence not desirable because it does not fall in the 80%-120% volume recovery range. On the other hand, the Resin D example exhibited a desirable volume recovery of 100%. Additionally, the Resin D example also demonstrated a higher protein recovery of 90%, whereas the Resin C example had a 77% protein recovery.

Therefore, this example demonstrates that Resin C as specified in Table 1 and Resin D as specified in Table 1 are superior to current commercially sold resins, Cytiva G 50, and Bio-Rad P-30; and further demonstrates at least certain advantages of using post modification chemistry in the Resin D example over the Resin C example.

### Example 12

In this example, the recovery of Goat Anti-Rabbit (GAR) Dy650 conjugate, and the removal of Free DyLight 650 of Resin C as specified in Table 1 was compared to Resin D as specified in Table 1. GAR 1 mg/mL was conjugated to NHS DyLight 650 at 7 molar excess. The free dye was removed by passing 100 μL of the conjugate through 500 μL bed volume of the Resin C example and the Resin D example. The conjugate before and after clean-up was diluted in 1× gel loading sample buffer and added at 10 μL/well on a gel. The gel was then scanned on IBright imager and the bands corresponding to the GAR conjugate and free dye were conjugated using myImage Analysis software.

As can be seen in FIG. 17, the Resin C example had a 99% free dye removal efficiency (Free DyLight 650), and the Resin D example had a 95% free dye removal efficiency (Free DyLight 650). Furthermore, as shown in FIG. 17, the Resin D example had an 81% GAR DyLight 650 conjugate removal and the Resin C example had 68% GAR DyLight 650 conjugate removal. Therefore, this example demonstrates at least certain advantages of post modification chemistry with MJ in the Resin D example resulting in comparable free dye removal efficiency to the Resin C example but a higher GAR recovery percentage than the Resin C example.

### Example 13

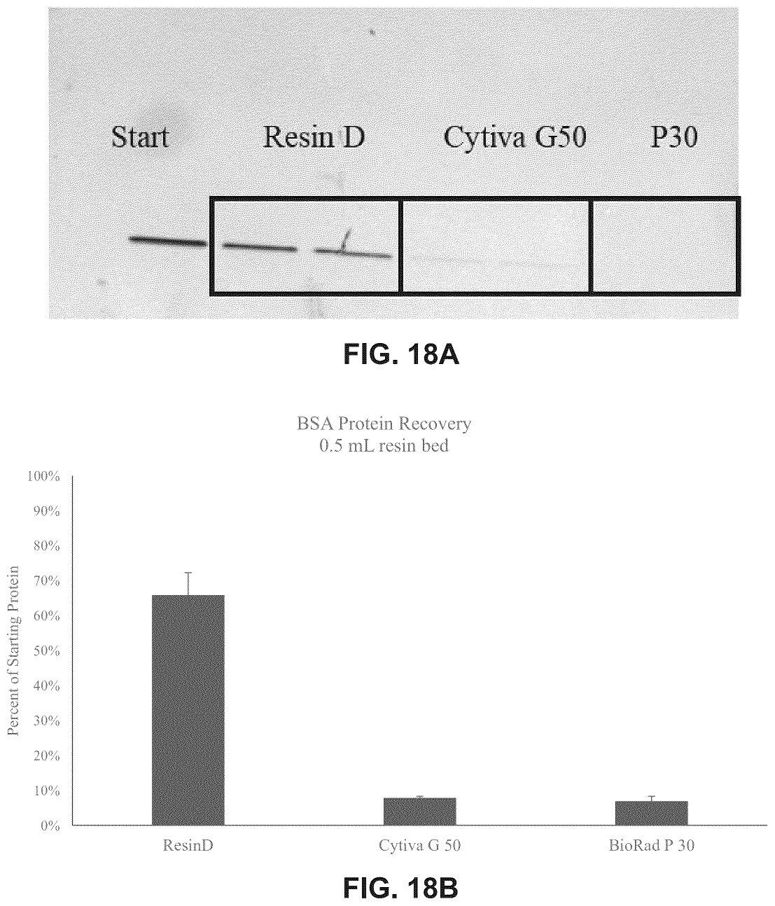

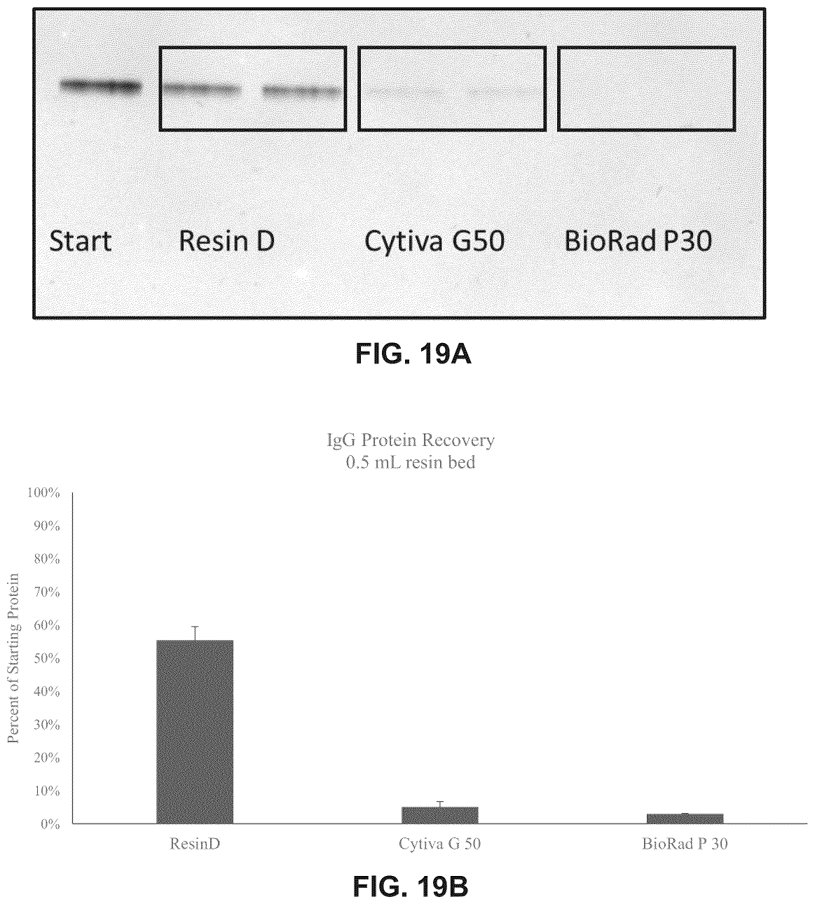

In this example, the recovery of BSA (250 ng load) and IgG (250 ng load) of Resin D as specified in Table 1 was compared to Cytiva G 50 and Bio-Rad P-30. FIG. 18A is a silver-stain gel showing the recovery of 250 ng BSA loaded onto the Resin D example, Cytiva G 50, and Bio-Rad P-30. FIG. 18B is a bar graph band quantification from silver-stained gel of FIG. 18A using iBright Image Analysis software indicating the BSA recovery percentage. FIG. 19A is the silver-stain gel showing the recovery of 250 ng IgG loaded onto the Resin D example, Cytiva G 50, and Bio-Rad P 30. FIG. 19B is a bar graph showing band quantification from silver-stained gel of FIG. 19A using iBright Image Analysis software indicating the IgG recovery percentage.

The band in the silver-stained gel in FIG. 18A corresponds to the recovered BSA. Furthermore, the bar graph shown in FIG. 18B shows a 66% BSA recovery for the Resin D example, an 8% BSA recovery for Cytiva G 50, and a 7% BSA recovery for Bio-Rad P-30. Accordingly, the Resin D example demonstrated superior recovery of low BSA amounts in comparison to the Cytiva G 50 and Bio-Rad P-30 resins.

The band in the silver-stained gel in FIG. 19A corresponds to the recovered IgG. Moreover, the bar graph depicted in FIG. 19B shows a 55% IgG recovery for the Resin D example, 5% IgG recovery in Cytiva G 50, and 3% IgG recovery in Bio-Rad P-30. Thus, the Resin D example also outperformed the Cytiva G 50 and Bio-Rad P-30 resins in recovering low IgG amounts.

### Example 14

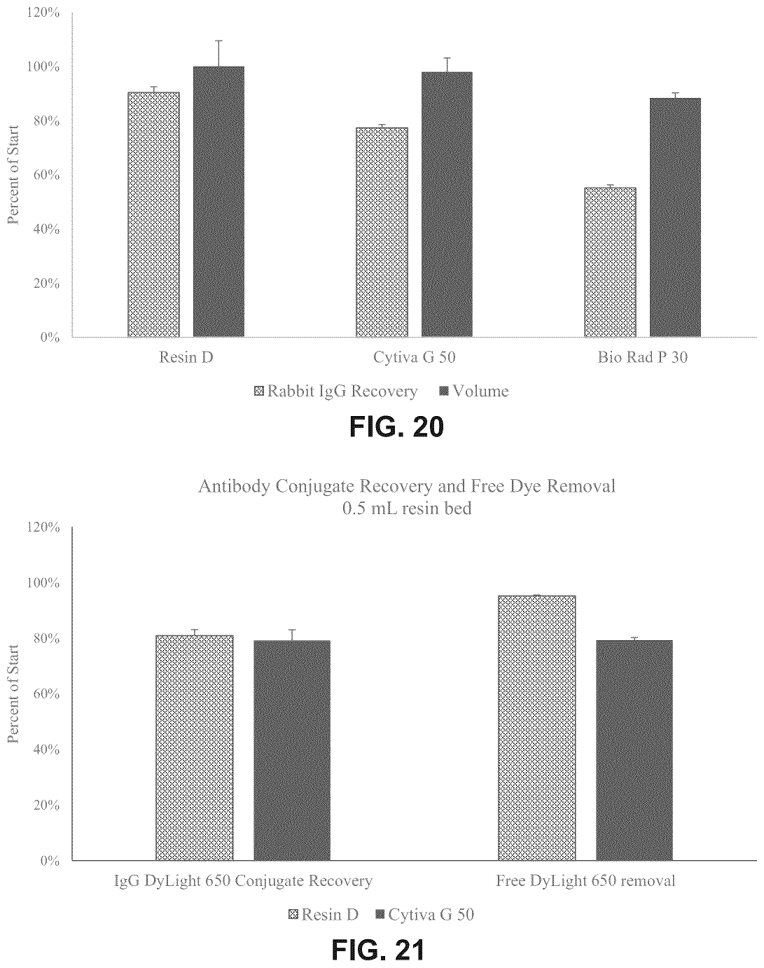

In this example, the rabbit IgG recovery (100 μg on 10 mL spin column) and volume recovery of Resin D as specified in Table 1 was compared to Cytiva G 50 and Bio-Rad P-30. FIG. 20 is a bar graph showing the rabbit IgG recovery percentage where 100 μg of rabbit IgG was loaded at 1 mL to the resin bed for the Resin D example, Cytiva G 50, and Bio-Rad P-30. Additionally, FIG. 20 shows the volume recovery percentage for 1 mL of 0.1 mg/mL rabbit IgG added to 10 mL of resin bed for the Resin D example, Cytiva G 50, and Bio-Rad P-30.

As can be seen in FIG. 20, the Resin D example had a rabbit IgG recovery of 90%, Cytiva G 50 had a 77% rabbit IgG recovery, and Bio-Rad P-30 had a 55% rabbit IgG recovery. Moreover, the Resin D example had a volume recovery of 100%, Cytiva G 50 had a volume recovery of 98%, and Bio-Rad P-30 had a volume recovery of 88%. Therefore, the Resin D example, Cytiva G 50, and Bio-Rad P-30 had a volume recovery within a desired range of 80% to 120%; however, the Resin D example demonstrated superior performance for recoveries at low protein amounts when compared to Cytiva G 50 and Bio-Rad P-30.

### Example 15

In this example, the recovery of Goat Anti-Rabbit (GAR) Dy650 conjugate and removal of Free DyLight 650 when 0.1 mg of GAR conjugated with DyLight 650 applied at 100 μL to 500 μL of the Resin D example as specified in Table 1 was compared to Cytiva G 50. 1 mg/mL Goat Anti Rabbit (GAR) was conjugated to NHS DyLight 650 at 7 molar excess. The free dye was removed by passing 100 μL of the conjugate through 500 μL bed volume of the Resin D example and Cytiva G 50. The conjugate before and after clean-up was diluted in 1× gel loading sample buffer and added at 10 μL/well on a gel. The gel was then scanned on Bright imager and the bands corresponding to the GAR conjugate and free dye were quantitated using myImage Analysis software.

FIG. 21 is a bar graph showing the GAR recovered percentage and the Free Dylight 650 removed of the Resin D example and Cytiva G 50. Accordingly, the Resin D example recovered 81% GAR and Cytiva G 50 recovered 79% GAR. Moreover, the Resin D example removed 95% Free DyLight 650 and Cytiva G 50 removed 79% Free DyLight 650.

Although the recovery of the GAR daylight 650 conjugate was comparable between the Resin D example and Cytiva G 50, the present example demonstrated a greater percentage of free dye removed for the Resin D example than Cytiva G 50.

### Example 16

In this example, the flowthrough of Resin D as specified in Table 1 was compared to Cytiva G 50 and Bio-Rad P-30 after loading A 549 lysate. 0.1 mg/mL A lysate was loaded at 50 μL on the resins (5 μg load). The resins were equilibrated three times with 300 μL PBS and spun at 700×g in a centrifuge. The A 549 lysate was then loaded at 5 μg's to the resins and collected after spinning at 700×g in a centrifuge. The flowthroughs were then diluted in gel loading sample buffer and was loaded at 25 μL/well on a 4-20% Tris Glycine gel. The gel was the stained with silver stain reagent.

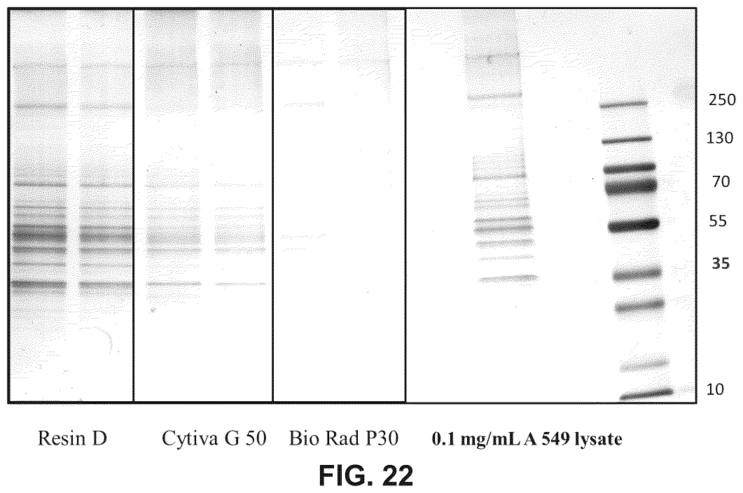

FIG. 22 is an image of a gel showing flowthrough collected after loading 50 μg of A 549 lysate on Resin D, Cytiva G 50, and Bio Rad P 30 resins. As can be seen in FIG. 22, the bands above 40,000 Da is much darker for the Resin D example than for Cytiva G 50 and Bio-Rad P-30 and hence indicates a higher protein recovery with molecular weights greater than 40,000 Da.

Therefore, this example demonstrated the superior performance of the Resin D example having higher protein recoveries than Cytiva G 50 and Bio-Rad P-30.

The present disclosure has been disclosed with reference to certain particular exemplary aspects. A person of ordinary skill in the art will understand that the present disclosure is not limited to the scope of those exemplary aspects. Instead, the scope of the present disclosure is determined by the following claims.

We claim:

1. A matrix, comprising:
at least one amine-containing moiety; and
a porous size exclusion support having a molecular weight cut-off ranging from greater than 30,000 Da to 45,000 Da and comprising 2-hydroxyethyl cellulose crosslinked with a heterocyclic compound having a structure according to Formula I, 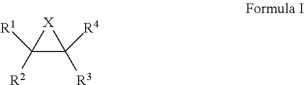
wherein:
X is a heteroatom selected from nitrogen, oxygen, or sulfur; and
each of R¹, R², R³, and R⁴ is independently selected from aliphatic, heteroaliphatic, haloaliphatic, halo, or glycidyl ether;
wherein the at least one amine-containing moiety is associated with the porous size exclusion support.

2. The matrix of claim 1, wherein the heterocyclic compound is epichlorohydrin.

3. The matrix of claim 1, wherein the porous size exclusion support is formed by reacting an amount of 2-hydroxyethyl cellulose ranging from greater than 0 grams to 200 grams with an amount of epichlorohydrin ranging from greater than 0 milliliters to 400 milliliters.

4. The matrix of claim 1, wherein the porous size exclusion support further comprises at least one modification reagent comprising epoxybutane, epoxyhexane, epoxypropane, dimethylsulfate, episulfide, disulfide, azirine, diazirine, diglycidyl ether, or any combination thereof.

5. The matrix of claim 1, wherein the at least one amine-containing moiety is covalently bound to the porous size exclusion support.

6. The matrix of claim 1, wherein, prior to association with the porous size exclusion support, the at least one amine-containing moiety is a monoamine, a diamine, or a polyamine.

7. The matrix according to claim 6, wherein, prior to association with the porous size exclusion support, the at least one amine-containing moiety has structure according to Formula V 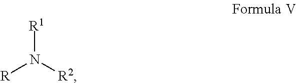
wherein:
(i) at least one of R, R¹, and R² is hydrogen;
(ii) at least one of R, R¹, and R² is aliphatic, heteroaliphatic, aryl, or heteroaryl; and
(iii) the remaining R, R¹, or R² is hydrogen, aliphatic, heteroaliphatic, aryl, or heteroaryl.

8. The matrix according to claim 7, wherein at least one of R, R¹ and R² is hydrogen, and the remaining R, R¹, or R² groups independently are C₁-C₁₀ aliphatic.

9. The matrix according to claim 8, wherein at least one of R, R¹ and R² is hydrogen, and remaining R, R¹ and R² groups are independently methyl, ethyl, propyl, isopropyl, butyl, sec-butyl, tertiary butyl, pentyl, isopentyl, hexyl, or isohexyl.

10. The matrix according to claim 6, wherein, prior to association with the porous size exclusion support, the at least one amine-containing moiety is a diamine having a structure according to Formula VI, 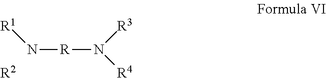
wherein:
(i) R is aliphatic, heteroaliphatic, aryl, or heteroaryl,
(ii) at least one of R¹, R², R³ and R⁴ is hydrogen, and
(iii) the remaining R¹, R², R³ and R⁴ are independently hydrogen, aliphatic, heteroaliphatic, aryl, or heteroaryl.

11. The matrix of claim 10, wherein the at least one amine-containing moiety is a diamine having a structure according to Formula VII,
H₂N—R—NH₂ Formula VII
wherein R is C₁-C₁₀ aliphatic, heteroaliphatic, aryl, or heteroaryl.

12. The matrix according to claim 11, wherein, prior to association with the porous size exclusion support, the at least one amine-containing moiety is 1,5-diaminopentane and wherein greater than 0 mg 1,5-diaminopentane per mL of the porous size exclusion support to 10 mg 1,5-diaminopentane per mL of the porous size exclusion support is used to form the matrix.

13. The matrix according to claim 6, wherein, prior to association with the porous size exclusion support, the at least one amine-containing moiety is a monoamine having a structure according to Formula VIII, 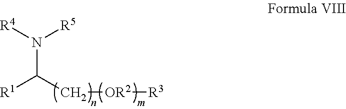
wherein:
R¹ is hydrogen, aliphatic, heteroaliphatic, aryl, or heteroaryl;
R² and R³ are independently aliphatic, heteroaliphatic, aryl, or heteroaryl;
at least one of R⁴ and R⁵ is hydrogen, and the remaining R⁴ group or R⁵ group is hydrogen, aliphatic, heteroaliphatic, aryl, or heteroaryl; and
each of m and n independently is an integer selected from 1 to 10.

14. The matrix according to claim 13, wherein the amine-containing moiety is O-(2-aminopropyl)-O′-(2-methoxyethyl)polypropylene glycol.

15. A device for separating one or more small molecules from one or more large molecules in a sample, the system comprising:
a container comprising a matrix according to claim 1, wherein the container has a volume ranging from 0.075 mL to 50 mL.

16. The device of claim 15, wherein container is a columnar container, a tube, a multi-well tube, a multi-well plate, or a multi-well filter plate.

17. The device of claim 15, further comprising a receptacle located below the container to collect a first flowthrough.

18. The device of claim 17, wherein the heterocyclic compound is epichlorohydrin; and wherein the porous size exclusion support is formed by reacting an amount of 2-hydroxyethyl cellulose ranging from greater than 0 grams to 200 grams with an amount of epichlorohydrin ranging from greater than 0 milliliters to 400 milliliters.

19. The device of claim 15, wherein the porous size exclusion support has a MWCO of 40,000 Da; and wherein the one or more small molecules has a molecular weight less than or equal to 40,000 Da and the one or more large molecules has a molecular weight of 40,000 Da or greater.

20. The device of claim 19, wherein the one or more small molecules is a biomolecule; a salt; an unreacted label or partially reacted label or nanoparticle, or a derivative thereof; a dye or derivative thereof; a radioactive ligand or an intermediate thereof; a mass tag; a metal; biotin or a derivative thereof; a crosslinker or derivative thereof; a reducing agent or derivative thereof; or any combination thereof.

21. A kit for separating one or more large molecules from one or more small molecules in a sample, the kit comprising the device of claim 18, wherein the device is operably configured to operate by gravity flow, a centrifugal force, a positive pressure, a negative pressure, vacuum, or any combination thereof.

22. The kit of claim 21, wherein the kit further comprises a buffer.

23. A method for separating one or more large molecules from one or more small molecules, the method comprising:
adding a sample comprising the one or more large molecules and the one or more small molecules to the matrix of claim 1; and
subjecting the matrix to a gravity flow, a centrifugal force, a positive pressure, a negative pressure, a vacuum, or any combination thereof, wherein the one or more large molecules is excluded by the matrix and is collected as a flow-through.
